(19) United States
(12) Patent Application Publication
(10) Pub. No.: US 2024/0297935 A1
(43) Pub. Date: Sep. 5, 2024

(54) PROGRAM, INFORMATION PROCESSING SYSTEM AND INFORMATION PROCESSING METHOD

(71) Applicant: RevComm Inc., Tokyo (JP)

(72) Inventors: Takeshi Aida, Tokyo (JP); Takekatsu Hiramura, Tokyo (JP)

(73) Assignee: RevComm Inc., Tokyo (JP)

(21) Appl. No.: 18/654,434

(22) Filed: May 3, 2024

Related U.S. Application Data
(63) Continuation of application No. PCT/JP2022/042637, filed on Nov. 17, 2022.

(30) Foreign Application Priority Data
Nov. 22, 2021 (JP) 2021-189132

(51) Int. Cl. H04M 3/436; H04M 3/42

(52) U.S. Cl. CPC H04M 3/436; H04M 3/42221; H04M 2203/555

(57) ABSTRACT

A program that makes a processor perform a detection step of detecting a start of a call with a customer stored in a CRM system and a linkage step of transmitting, to the CRM system, a request for storing call data concerning the call with the customer in association with the customer.

### CROSS-REFERENCE TO RELATED APPLICATIONS

This application is based upon and claims the benefit of priority from the prior Japanese Patent Application(s) No. JP2021-189132, filed Nov. 22, 2021, the PCT Patent Applications(s) No. PCT/JP2022/042637, filed Nov. 17, 2022 the entire contents of which are incorporated herein by reference.

### FIELD

The present disclosure relates to a program, an information processing system and an information processing method.

### BACKGROUND

In conventional information processing systems for providing call services, there are known techniques for transmitting and receiving data concerning a call to and from an external information processing device.

Conventional system discloses a sales support system that allows a user of a client terminal to input by voice information in a fixed-form information input area so that the user can input information even in an environment that is not suitable for typing. Conventional system discloses a call audio data management method for a call center that improves work efficiency by managing call audio data in a database based on various kinds of management data generated from the call audio data, and an operator terminal suitable therefor. Conventional system discloses customer relationship management method, system and program that standardizes and records inbound data so that the inbound data can be used for marketing.

However, when storing data concerning a call in an external customer relationship management (CRM) system or the like, there is a problem that data cannot be stored in the CRM system at a time suitable for each process, such as a sales activity, of an individual user or organization.

The present disclosure has been devised to solve the problem described above, and an object of the present disclosure is to provide a technique for storing data concerning a call between a user and a customer in a CRM system at a time suitable for each process, such as a sales activity, of an individual user or organization.

### BRIEF DESCRIPTION OF THE DRAWINGS

FIG. 1 is a diagram showing an entire configuration of an information processing system 1.

FIG. 2 is a block diagram showing a functional configuration of a server 10.

FIG. 3 is a block diagram showing a functional configuration of a user terminal 20.

FIG. 4 is a block diagram showing a functional configuration of a CRM system 30.

FIG. 5 is a block diagram showing a functional configuration of a customer terminal 50.

FIG. 6 is a diagram showing a data structure of a user table 1012.

FIG. 7 is a diagram showing a data structure of an organization table 1013.

FIG. 8 is a diagram showing a data structure of a call table 1014.

FIG. 9 is a diagram showing a data structure of an audio recognition table 1015.

FIG. 10 is a diagram showing a data structure of a summary table 1016.

FIG. 11 is a diagram showing a data structure of a conversation memorandum table 1017.

FIG. 12 is a diagram showing a data structure of a customer table 3012.

FIG. 13 is a diagram showing a data structure of a conversation history table 3013.

FIG. 14 is a flowchart showing an operation of summarization processing (first example).

FIG. 15 is a flowchart showing an operation of summarization processing (second example).

FIG. 16 is a flowchart showing an operation of conversation memorandum assignment processing.

FIG. 17 is a flowchart showing an operation of conversation memorandum suggestion processing.

FIG. 18 is a flowchart showing an operation of score calculation processing.

FIG. 19 is a flowchart showing an operation of CRM storage processing.

FIG. 20 is a flowchart showing an operation of call display processing.

FIG. 21 is a diagram showing an overview of binding processing in the summarization processing (first example).

FIG. 22 is a diagram showing an overview of additional extraction processing in the summarization processing (second example).

FIG. 23 is a diagram showing an overview of summary display processing.

FIG. 24 is a diagram showing an example screen of a CRM service in the call display processing.

FIG. 25 is a block diagram showing a basic hardware configuration of a computer 90.

### DETAILED DESCRIPTION

In general, according to one embodiment, a program for storing call data concerning a call between a user and a customer in an external CRM system, in an information processing system that comprises a processor and a storage unit and provides a call service between the user and the customer, wherein the program makes the processor perform: a detection step of detecting a start of the call with the customer stored in the CRM system; and a linkage step of transmitting, to the CRM system, a request for storing call data concerning the call with the customer in association with the customer.

In the following, embodiments of the present disclosure will be described with reference to the drawings. In all the drawings for describing the embodiments, like components are denoted by like reference numerals, and redundant descriptions thereof will be omitted. The embodiments described below are not intended to unreasonably limit the scope of the present disclosure described in the claims. Not all the components shown in the embodiments are essential components of the present disclosure. The drawings are schematic drawings and are not strictly drawn.

### <Overview of Information Processing System 1>

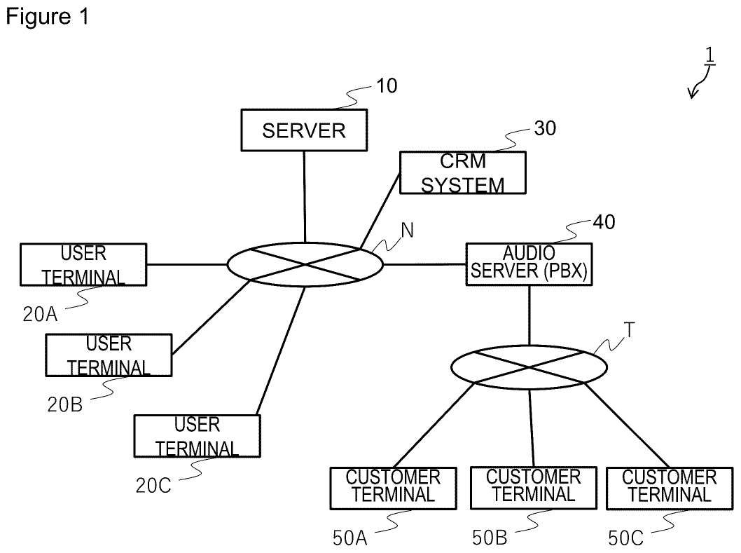

FIG. 1 is a diagram showing the entire configuration of an information processing system 1. The information processing system 1 according to the present disclosure is an information processing system that provides a call service according to the present disclosure. The information processing system 1 is an information processing system that provides a service concerning a call between a user and a customer, and stores and manages data concerning the call.

### <Basic Configuration of Information Processing System 1>

FIG. 1 shows the information processing system 1 according to the present disclosure. The information processing system 1 comprises a server 10, a plurality of user terminals 20A, 20B and 20C, a CRM system 30 and an audio server (PBX) 40 connected to each other via a network N, and customer terminals 50A, 50B and 50C connected to the audio server (PBX) 40 via a telephone network T.

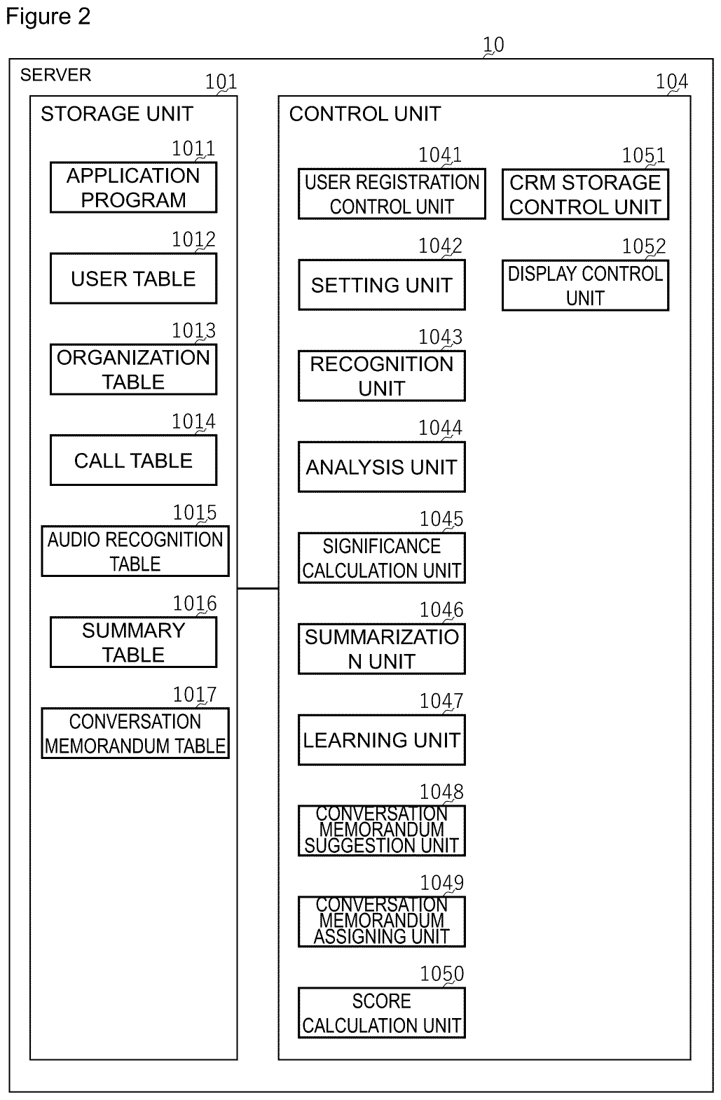

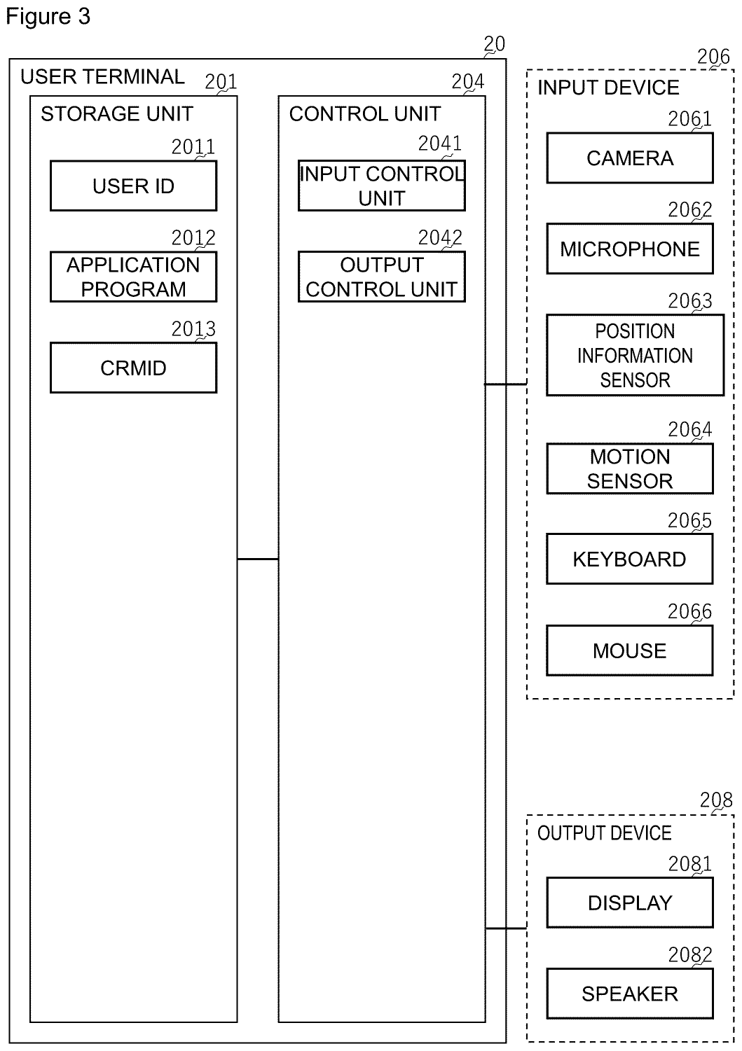

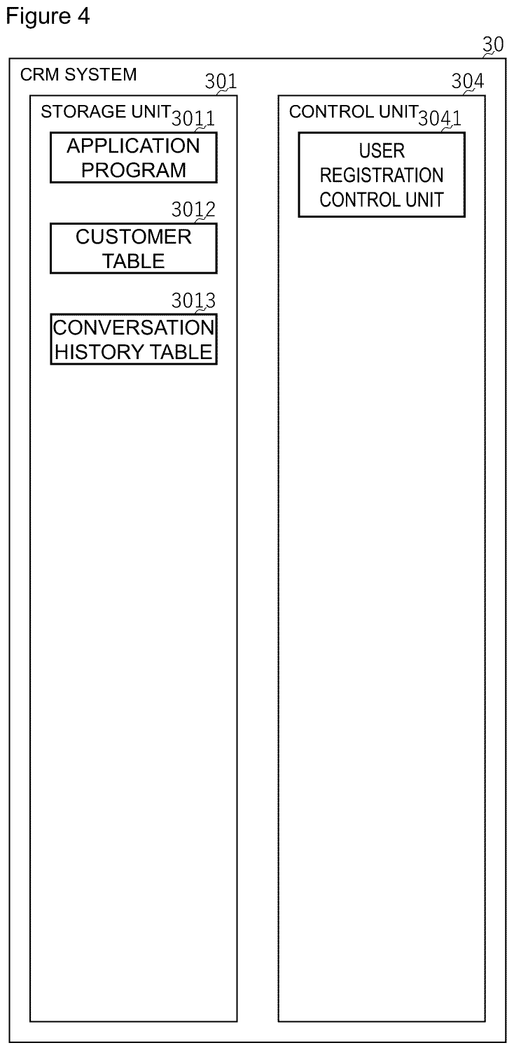

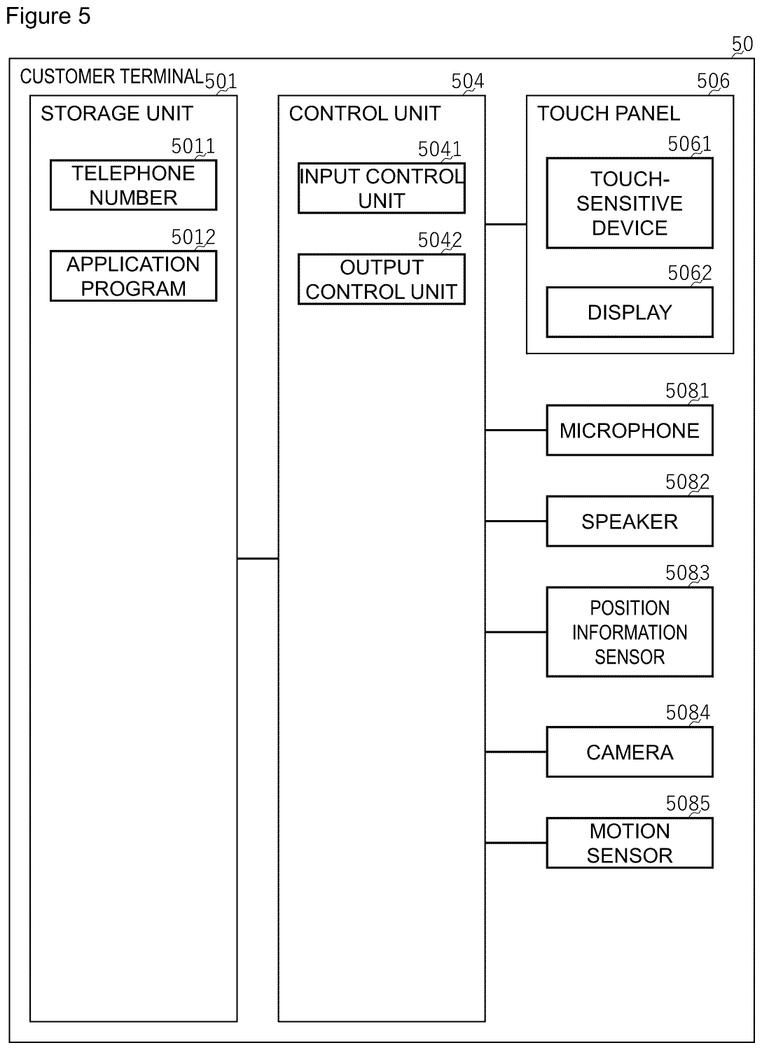

FIG. 2 is a block diagram showing a functional configuration of the server 10. FIG. 3 is a block diagram showing a functional configuration of a user terminal 20. FIG. 4 is a block diagram showing a functional configuration of the CRM system 30. FIG. 5 is a block diagram showing a functional configuration of the customer terminal 50.

The server 10 is an information processing device that provides a service for storing and managing data (call data) concerning a call between a user and a customer.

The user terminal 20 is an information processing device that is operated by the user using the service. The user terminal 20 may be a desktop personal computer (PC), a laptop PC or a mobile terminal, such as a smartphone or a tablet, for example. The user terminal 20 may also be a wearable terminal, such as a head mount display (HMD) or a watch-type terminal.

The CRM system 30 is an information processing device that is managed and operated by an operator (CRM operator) that provides a customer relationship management (CRM) service. CRM services include SalesForce, HubSpot, Zoho CRM, and kintone, for example.

The audio server (PBX) 40 is an information processing device is an information processing device that serves as an exchange that connects the network N and the telephone network T to allow a call between the user terminal 20 and the customer terminal 50.

The customer terminal 50 is an information processing device that is operated by the customer when calling the user. The customer terminal 50 may be a mobile terminal, such as a smartphone or a tablet, a desktop personal computer (PC) or a laptop PC, for example. The customer terminal 50 may also be a wearable terminal, such as a head mount display (HMD) or a watch-type terminal.

Each information processing device is formed by a computer comprising an arithmetic device and a storage device. A basic hardware configuration of the computer and a basic functional configuration of the computer implemented by the hardware configuration will be described later. For the basic hardware configurations and basic functional configuration of the server 10, the user terminal 20, the CRM system 30, the audio server (PBX) 40 and the customer terminal 50, if there are the same parts as those of the computer described later, descriptions of those parts will be omitted.

In the following, configurations and operations of the devices will be described.

### <Basic Configuration of Server 10>

FIG. 2 shows a functional configuration of the server 10 implemented by a hardware configuration thereof. The server 10 comprises a storage unit 101 and a control unit 104.

### <Configuration of Storage Unit of Server 10>

The storage unit 101 of the server 10 comprises an application program 1011, a user table 1012, an organization table 1013, a call table 1014, an audio recognition table 1015, a summary table 1016, and a conversation memorandum table 1017.

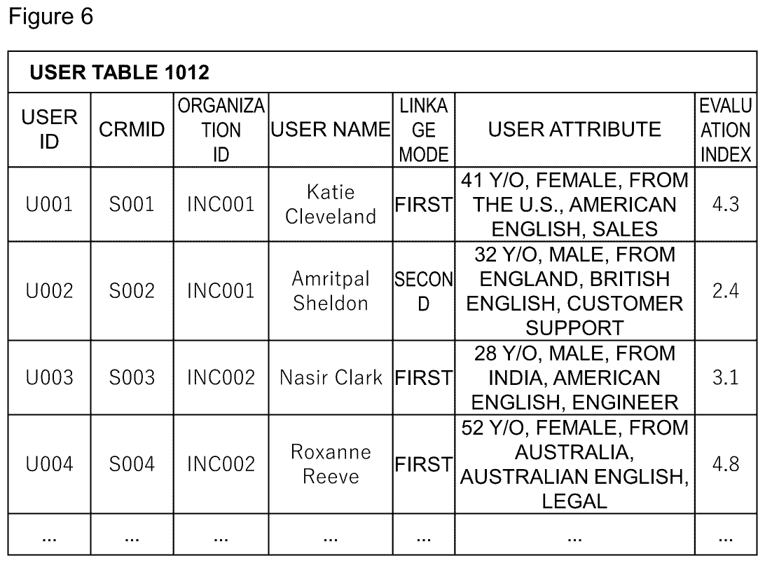

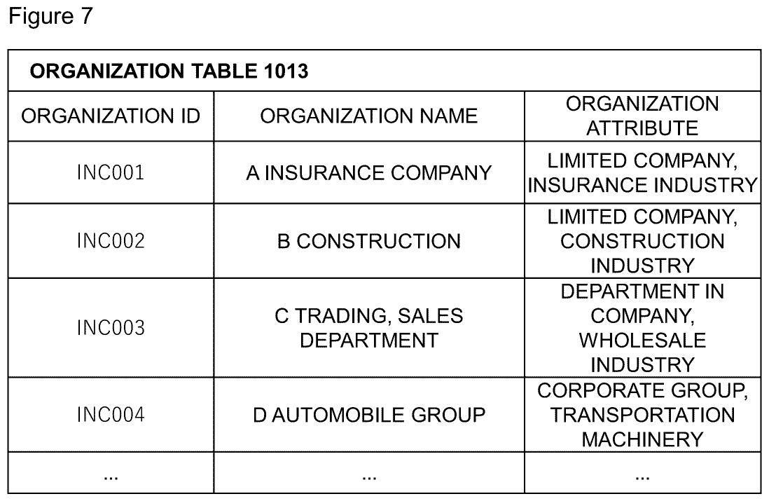

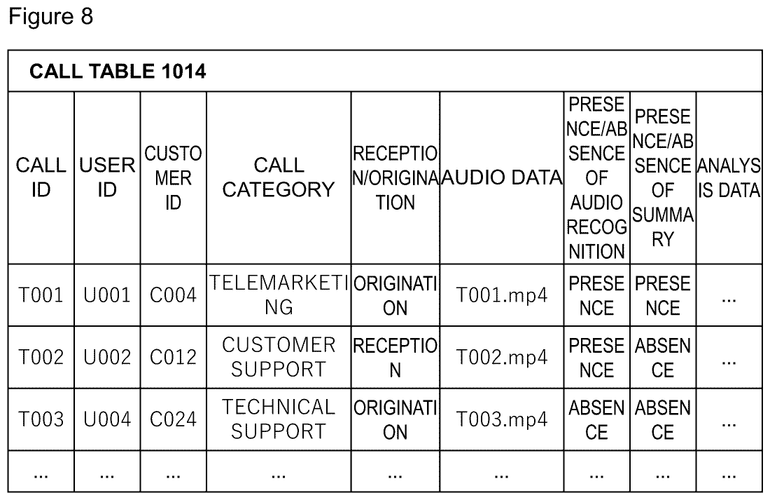

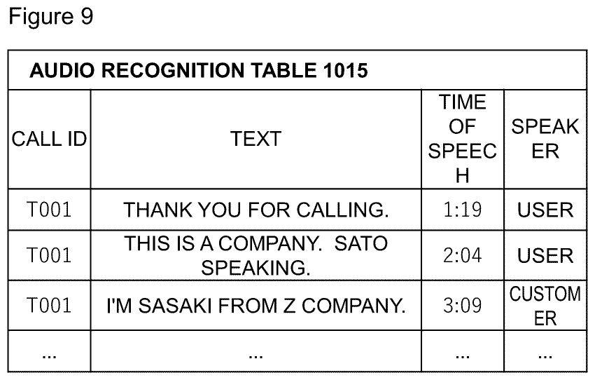

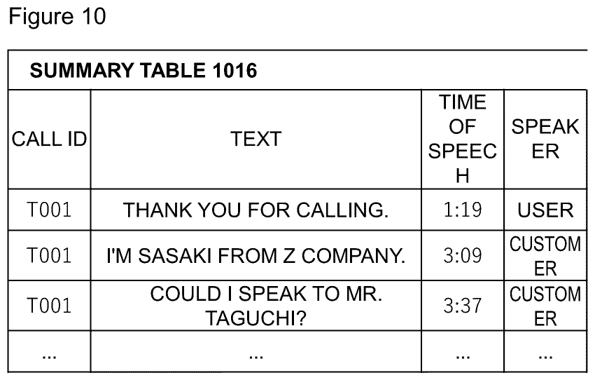

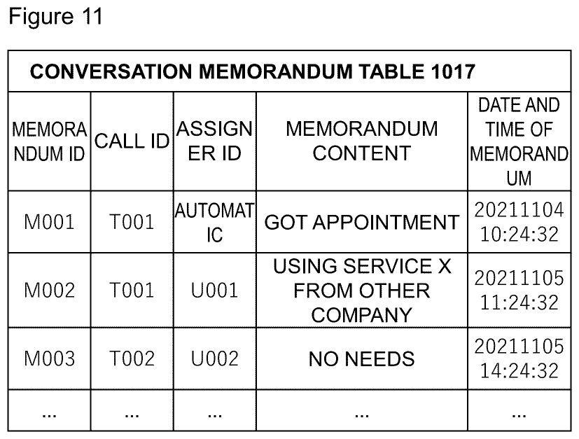

FIG. 6 is a diagram showing a data structure of the user table 1012. FIG. 7 is a diagram showing a data structure of the organization table 1013. FIG. 8 is a diagram showing a data structure of the call table 1014. FIG. 9 is a diagram showing a data structure of the audio recognition table 1015. FIG. 10 is a diagram showing a data structure of the summary table 1016. FIG. 11 is a diagram showing a data structure of the conversation memorandum table 1017.

The user table 1012 is a table for storing and managing information about a membership user (referred to as a user, hereinafter) using a service. When a user registers for use of the service, information about the user is stored in a new record of the user table 1012. This enables the user to use the service according to the present disclosure. The user table 1012 includes the user ID as a primary key and includes columns of user ID, CRM ID, organization ID, user name, linkage mode, user attribute and evaluation index.

The user ID is an item for storing user identification information for identifying the user.

The CRM ID is an item for storing identification information for identifying the user in the CRM system 30. The user can be provided with a CRM service by logging in the CRM system 30 with the CRM ID. That is, the user ID in the server 10 and the CRM ID in the CRM system 30 are linked to each other.

The organization ID is an item for storing an organization ID of an organization to which the user belongs.

The user name is an item for storing the name of the user.

The linkage mode is an item for storing a setting item (linkage setting) when storing data concerning a call between the user and a customer in the CRM system.

Although the linkage mode is described as being stored for each user in the present disclosure, the linkage mode may be stored in the organization table for each organization or department. In that case, the linkage mode applied to each user is applied to the user by referring to the linkage mode for each organization or department stored in the organization table. In this process, the same linkage mode can be applied to the users belonging to the same organization or department.

The user attribute is an item for storing information about an attribute of the user, such as the age, sex, birthplace, dialect or job category (such as sales or customer support) of the user.

The evaluation index is an item for storing a quantitative evaluation index of the telephone conversation skills of the user. Specifically, the evaluation index is a numeric value calculated by applying a predetermined algorithm to an index (such as talk-to-listen ratio, number of silences, number of interruptions, number of verbal exchanges, fundamental frequency, change in intonation, speech rate, number of fillers or degree of adherence to a talk script) of analysis data described later obtained by analysis of past audio data of the user.

In the field of inside sales, for example, the evaluation index corresponds to the customer conversation skills for the user quantitatively expressed, and the higher the evaluation index, the higher the expectation of sales results of the user becomes.

The organization table 1013 is a table for defining information about the organization to which the user belongs. The organization may be any organization or group, such as a company, a corporation, a corporate group, a circle or an association. The organization may be defined for each, more detailed, sub-group, such as for each department (such as sales department, general affairs department or customer support department) in a company. The organization table 1013 includes the organization ID as a primary key and includes columns of organization ID, organization name and organization attribute.

The organization ID is an item for storing organization identification information for identifying the organization.

The organization name is an item for storing the name of the organization. The name of the organization may be any organization name or group name, such as a company name, a corporation name, a corporate group name, a circle name or an association name.

The organization attribute is an item for storing information about an attribute of the organization, such as the type of the organization (such as a company, a corporate group or an association) or the category of business (such as real estate business or financial business).

The call table 1014 is a table for storing and managing call data concerning a call between the user and a customer. The call table 1014 includes the call ID as a primary key and includes columns of call ID, user ID, customer ID, call category, reception/origination, audio data, presence/absence of audio recognition, present/absence of summary and analysis data.

The call ID is an item for storing call data identification information for identifying call data.

The user ID is an item for storing the user ID (user identification information) of the user in the call between the user and the customer.

The customer ID is an item for storing the customer ID (customer identification information) of the customer in the call between the user and the customer.

The call category is an item for storing the type (category) of the call between the user and the customer. The call data is classified according to the call category. As the call category, a value for the telephone operator, the telemarketing, the customer support, the technical support or the like is stored, depending on the purposes of the call between the user and the customer, for example.

The reception/origination is an item for storing information for distinguishing whether the call between the user and the customer is originated by the user (outbound) or received by the user (inbound).

The audio data is an item for storing audio data of the call between the user and the customer. As the format of the audio data, various formats of audio data, such as mp4 or wav, can be used. The audio data may be an item for storing reference information (pass) about an audio data file disposed at another place.

The audio data may be data in a format in which identifiers are set so that the audio of the user and the audio of the customer can be independently identified. In that case, the control unit 104 of the server 10 can separately perform analysis processing on the audio of the user and the audio of the customer.

In the present disclosure, video data including audio information may be used instead of the audio data. The audio data in the present disclosure conceptually includes audio data included in video data.

The presence/absence of audio recognition is an item for storing information for determining whether audio recognition processing has been performed on the audio data of the call between the user and the customer. When audio recognition processing has been performed on the audio data, information indicating that audio recognition processing has been performed is stored, for example. When audio recognition processing has not been performed on the audio data, a blank, a null or other information indicating that audio recognition processing has not been performed is stored.

The presence/absence of summary is an item for storing information for determining whether summarization processing has been performed on the audio data of the call between the user and the customer. When summarization processing has been performed, information indicating that summarization processing has been performed is stored, for example. When summarization processing has not been performed, a blank, a null or other information indicating that summarization processing has not been performed is stored.

The analysis data is an item for storing analysis data obtained by analyzing the audio of the audio data of the call between the user and the customer. The analysis data includes the talk-to-listen ratio, the number of silences, the number of interruptions, the number of verbal exchanges, the fundamental frequency, the change in intonation, the speech rate, the number of fillers and the degree of adherence to a talk script, for example.

The audio recognition table 1015 is a table that stores audio recognition information including the time of speech, the speaker and text obtained by performing audio recognition processing on the audio data of the call between the user and the customer. The audio recognition table 1015 includes columns of call ID, text, time of speech and speaker.

The call ID is an item for storing a call ID (call data identification information) of call data from which the audio recognition information is generated.

The text is an item for storing text information of a text recognition result for each section (speech section) containing audio of the audio data of the call between the user and the customer. Specifically, textual content spoken by the speaker is stored as text data for each speech section of the audio data.

The time of speech is an item for storing the time of start of the audio data (sectional audio data) in the speech section. The time of speech can be any time associated with a speech section, such as the time of start of a speech section, the time of end of a speech section, or any point in time in a speech section.

As the speaker, information for identifying the speaker of the sectional audio data is stored. Specifically, the speaker is an information for identifying the user or the customer. User identification information, customer identification information or the like for identifying the speaker, such as the user ID or the customer ID, may also be stored.

The summary table 1016 is a table that stores summary information including the time of speech, the speaker and text obtained by performing summarization processing on the audio recognition information about the call between the user and the customer. The summary information is information including text that is associated with and characterizes the call between the user and the customer. The user can quickly grasp the content of the call between the user and the customer by referring to the summary information. The summary table 1016 includes columns of call ID, text, time of speech and speaker.

The call ID is an item for storing a call ID (call data identification information) of call data from which the summary information is generated.

The text is an item for storing text of the audio recognition information extracted as the summary information.

The time of speech is an item for storing the time of speech of the audio recognition information extracted as the summary information.

The speaker is an item for storing the speaker of the audio recognition information extracted as the summary information.

The conversation memorandum table 1017 is a table that stores and manages information about a conversation memorandum stored and linked with the call data concerning the call between the user and the customer. The user can sort and manage a large amount of call data by setting a conversation memorandum for (assigning a conversation memorandum to) the call data. The server 10 can change processing conditions for various types of control processing by using the conversation memorandums assigned to the call data. The conversation memorandum table 1017 includes the memorandum ID as a primary key and includes columns of memorandum ID, call ID, assigner ID, memorandum content and date and time of memorandum.

The memorandum ID is an item for storing conversation memorandum identification information for identifying the conversation memorandum.

The call ID is an item for storing the call ID (call data identification information) of the call data to which the conversation memorandum is assigned.

The assigner ID is an item for storing the user ID of the user who assigned the conversation memorandum to the call data.

The memorandum content is an item for storing the content of the conversation memorandum assigned to the call data. The memorandum content is typically character string (text) information.

The date and time of memorandum is an item for storing the date and time when the user assigned the conversation memorandum to the call data.

### <Configuration of Control Unit of Server 10>

The control unit 104 of the server 10 comprises a user registration control unit 1041, a setting unit 1042, a recognition unit 1043, an analysis unit 1044, a significance calculation unit 1045, a summarization unit 1046, a learning unit 1047, a conversation memorandum suggestion unit 1048, a conversation memorandum assigning unit 1049, a score calculation unit 1050, a CRM storage control unit 1051 and a display control unit 1052. The control unit 104 implements the functional units by executing the application program 1011 stored in the storage unit 101.

The user registration control unit 1041 performs processing of storing information about the user who wants to use the service according to the present disclosure in the user table 1012.

The user transmits information to be stored in the user table 1012, such as the user ID, the user name and the user attribute, to the server 10 by opening a website or the like operated by the service provider on an arbitrary information processing terminal, inputting the user ID, the user name and the user attribute in a predetermined input form, and transmitting these items of information to the server 10. The user registration control unit 1041 of the server 10 stores the received user ID, user name and user attribute in a new record of the user table 1012, thereby completing the user registration. Once these items of user information are stored in the user table 1012, the user can use the service.

Before the registration of the user information in the user table 1012 by the user registration control unit 1041, the service provider may perform a predetermined examination of the user to limit the use of the service by the user.

The user ID can be any character or numeric string that enables identification of the user. The user may set any desired character or numeric string, or the user registration control unit 1041 of the server 10 may automatically set an arbitrary character or numeric string.

In the user registration, the user registration control unit 1041 may link organization information of the organization to which the user belongs, such as organization ID, organization name or organization attribute, with the user and store the organization information linked with the user in the organization table 1013. The information about the organization to which the user belongs may be input by the user or by an administrator of the organization to which the user belongs or the operator of the service according to the present disclosure, for example.

The setting unit 1042 performs linkage mode setting processing. This processing will be described in detail later.

The recognition unit 1043 performs audio recognition processing. This processing will be described in detail later.

The analysis unit 1044 performs audio analysis processing. This processing will be described in detail later.

The significance calculation unit 1045 performs significance calculation processing. This processing will be described in detail later.

The summarization unit 1046 performs summarization processing. This processing will be described in detail later.

The learning unit 1047 performs learning processing. This processing will be described in detail later.

The conversation memorandum suggestion unit 1048 performs conversation memorandum suggestion processing. This processing will be described in detail later.

The conversation memorandum assigning unit 1049 performs conversation memorandum assignment processing. This processing will be described in detail later.

The score calculation unit 1050 performs score calculation processing. This processing will be described in detail later.

The CRM storage control unit 1051 performs CRM storage processing. This processing will be described in detail later.

The display control unit 1052 performs call display processing. This processing will be described in detail later.

### <Functional Configuration of User Terminal 20>

FIG. 3 shows a functional configuration of the user terminal 20 implemented by a hardware configuration thereof. The user terminal 20 comprises a storage unit 201, a control unit 204, and an input device 206 and output device 208 connected to the user terminal 20. The input device 206 includes a camera 2061, a microphone 2062, a position information sensor 2063, a motion sensor 2064, a keyboard 2065 and a mouse 2066. The output device 208 includes a display 2081 and a speaker 2082.

### <Configuration of Storage Unit of User Terminal 20>

The storage unit 201 of the user terminal 20 stores a user ID 2011 for identifying the user who uses the user terminal 20, an application program 2012 and a CRM ID 2013.

The user ID is an account ID of the user for the server 10. The user transmits the user ID 2011 from the user terminal 20 to the server 10. The server 10 identifies the user based on the user ID 2011, and provides the service according to the present disclosure to the user. The user ID includes information, such as a session ID, temporarily assigned by the server 10 when identifying the user who is using the user terminal 20.

The CRM ID is an account ID of the user for the CRM system 30. The user transmits the CRM ID 2013 from the user terminal 20 to the CRM system 30. The CRM system 30 identifies the user based on the CRM ID 2013, and provides the CRM service to the user. The CRM ID 2013 includes information, such as a session ID, temporarily assigned by the CRM system 30 when identifying the user who is using the user terminal 20.

The application program 2012 may be previously stored in the storage unit 201 or may be downloaded via a communication IF from a web server or the like operated by the service provider. The application program 2012 includes an interpreter programming language, such as JavaScript®, executed on a web browser application stored in the user terminal 20.

### <Configuration of Control Unit of User Terminal 20>

The control unit 204 of the user terminal 20 comprises an input control unit 2041 and an output control unit 2042. The control unit 204 implements the input control unit 2041 and the output control unit 2042, which are the functional units thereof, by executing the application program 2012 stored in the storage unit 201.

The input control unit 2041 of the user terminal 20 obtains information output from the input device, such as the camera 2061, the microphone 2062, the position information sensor 2063, the motion sensor 2064, the keyboard 2065 or the mouse 2066, and performs various kinds of processing. The input control unit 2041 of the user terminal 20 performs processing of transmitting the information obtained from the input device 206 to the server 10 along with the user ID 2011. Similarly, the input control unit 2041 of the user terminal 20 performs processing of transmitting the information obtained from the input device 206 to the CRM system 30 along with the CRM ID 2013.

The output control unit 2042 of the user terminal 20 receives an operation of the input device 206 by the user and information from the server 10 and the CRM system 30, and performs control processing for the content to be displayed on the display 2081 connected to the user terminal 20 and the content to be audibly output by the speaker 2082 connected to the user terminal 20.

### <Functional Configuration of CRM System 30>

FIG. 4 shows a functional configuration of the CRM system 30 implemented by a hardware configuration thereof. The CRM system 30 comprises a storage unit 301 and a control unit 304.

The user has separately signed a contract with the CRM operator, and can be provided with the CRM service by accessing (logging in) a website operated by the CRM operator via a web browser or the like using the CRM ID 2013 set for the user.

### <Configuration of Storage Unit of CRM System 30>

The storage unit 301 of the CRM system 30 comprises a customer table 3012 and a conversation history table 3013.

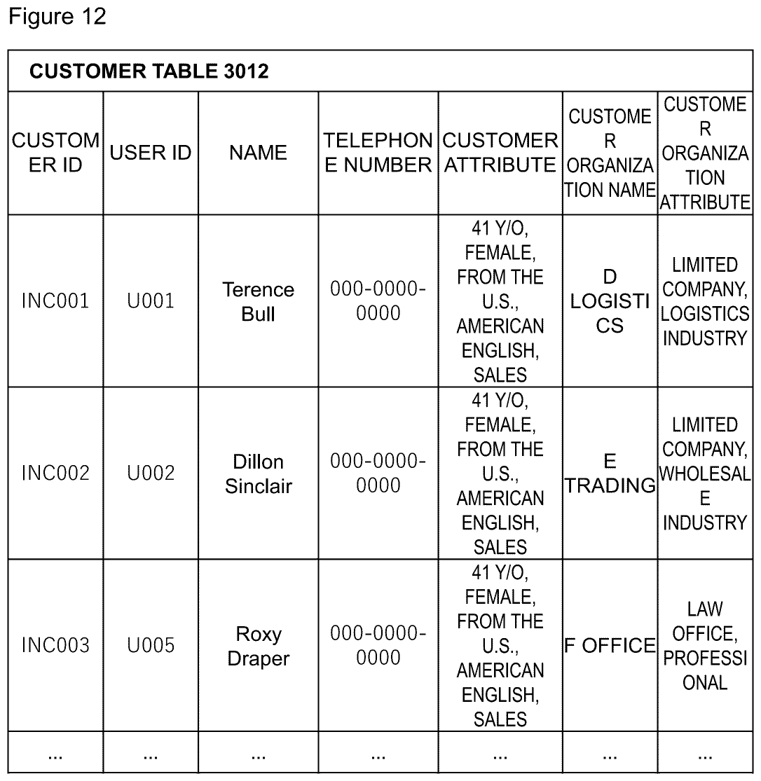

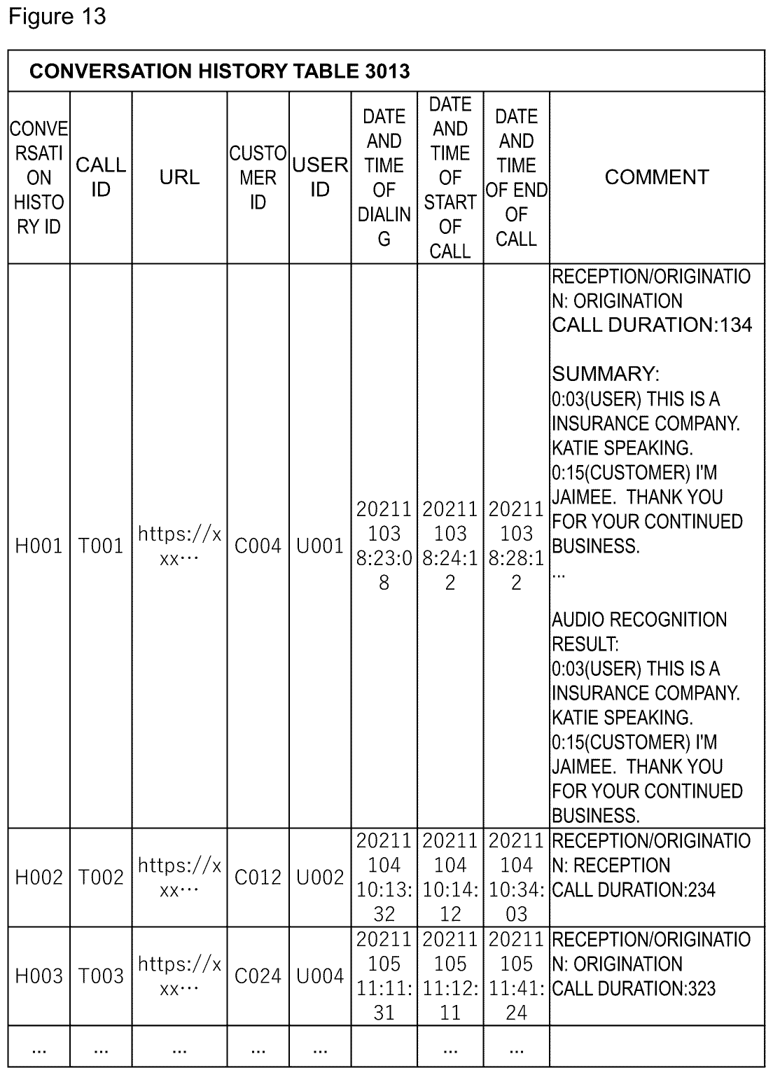

FIG. 12 is a diagram showing a data structure of the customer table 3012. FIG. 13 is a diagram showing a data structure of the conversation history table 3013.

The customer table 3012 is a table for storing and managing customer information. The customer table 3012 includes the customer ID as a primary key and includes columns of customer ID, user ID, name, telephone number, customer attribute, customer organization name and customer organization attribute.

The customer ID is an item for storing customer identification information for identifying the customer.

The user ID is an item for storing the user ID (user identification information) of the user linked with the customer. The user can bring up a list of customers linked with the user ID of the user or originate a call (make a call) to the customer.

Although the customer is described as being liked with the user in the present disclosure, the customer may be linked with the organization (organization ID in the organization table 1013). In that case, the user belonging to the organization can bring up a list of customers linked with the organization ID of the user or originate a call to the customer.

The name is an item for storing the name of the customer.

The telephone number is an item for storing the telephone number of the customer.

By accessing the website provided by the CRM system, selecting the customer to which the user wants to originate a call, and performing a predetermined manipulation such as “originate”, the user can originate a call to the telephone number of the customer from the user terminal 20.

The customer attribute is an item for storing information about an attribute of the customer, such as the age, sex, birthplace, dialect or job category (such as sales or customer support) of the customer.

The customer organization name is an item for storing a name of the organization to which the customer belongs. The name of the organization may be any organization name or group name, such as a company name, a corporation name, a corporate group name, a circle name or an association name.

The customer organization attribute is an item for storing information about an attribute of the organization, such as the category of the organization of the customer (such as company, corporate group or other associations) or the category of business (such as real estate business or financial business).

The customer attribute, the customer organization name and the customer organization attribute may be input and stored by the user or may be input by the customer accessing a predetermined website.

The conversation history table 3013 is a table for storing and managing a recording (conversation history information) of a customer conversation (conversation history). In the case of a customer conversation in sales activities, a recording of past sales activities (such as date and time or details of the sales activities) is stored. The conversation history table 3013 includes the conversation history ID as a primary key and includes columns of conversation history ID, call ID, URL, customer ID, user ID (originator), date and time of dialing, date and time of start of a call, date and time of end of a call, and comment.

In the present disclosure, each time a call is established between the user and the customer, a new record is created, and conversation history information is stored.

The conversation history ID is an item for storing conversation history identification information for identifying a conversation history.

The call ID is an item for storing the call ID (call data identification information) of the call data relating to the conversation history. This links the conversation history in the CRM system with the call data in the server 10.

The URL is uniform resource locator (URL) information including a character string that uniquely determines the call ID. The URL may directly include the call ID or may include a character string that allows decoding of the call ID or a particular character string that allows the call ID to be obtained by referring to a table not shown. By operating the browser on the user terminal 20 and accessing the URL, the user can see an analysis result screen in which analysis data of the call data relating to the conversation history is visualized.

The customer ID is an item for storing the customer ID (customer identification information) of the customer relating to the conversation history.

The user ID is an item for storing the user ID (user identification information) of the user relating to the conversation history.

The date and time of dialing is an item for storing the date and time when the user originated a call relating to the conversation history to the customer.

The date and time of start of a call is an item for storing the date and time of start of a call between the user and the customer relating to the conversation history.

The date and time of end of a call is an item for storing the date and time of end of a call between the user and the customer relating to the conversation history.

The comment is an item for storing text information, such as memorandum or comment, relating to the conversation history. The user can freely edit the comment by adding notes or matters to be handed over relating to the conversation history. The control unit 104 of the server 10 can freely edit the comment by transmitting a predetermined request to an application programming interface (API) of the CRM system 30.

### <Configuration of Control Unit of CRM System 30>

Th control unit 304 of the CRM system 30 comprises a user registration control unit 3041. The control unit 304 implements the functional unit by executing an application program 3011 stored in the storage unit 301.

The CRM system 30 provides functions referred to as application programming interface (API), software development kit (SDK) and code snippet (referred to as “beacon”, hereinafter). The user can link account information between the server 10 and the CRM system 30 according to the present disclosure in advance, thereby allowing the control unit 104 of the server 10 and the control unit 304 of the CRM system 30 to communicate with each other and achieve any information processing.

### <Overview of Audio Server (PBX) 40>

When the user originates a call to the customer, the audio server (PBX) 40 originates a call to (calls) the customer terminal 50.

When the customer originates a call to the user, the audio server (PBX) 40 transmits a message to that effect (referred to as an “incoming call notification message”, hereinafter) to the user terminal 20. The audio server (PBX) 40 can transmit the incoming call notification message to the beacon, SDK, API and the like provided by the server 10.

### <Functional Configuration of Customer Terminal 50>

FIG. 5 shows a functional configuration of the customer terminal 50 implemented by a hardware configuration thereof. The customer terminal 50 comprises a storage unit 501, a control unit 504, a touch panel 506, a touch-sensitive device 5061, a display 5062, a microphone 5081, a speaker 5082, a position information sensor 5083, a camera 5084 ad a motion sensor 5085.

### <Configuration of Storage Unit of Customer Terminal 50>

The storage unit 501 of the customer terminal 50 stores a telephone number 5011 of the customer using the customer terminal 50 and an application program 5012.

The application program 5012 may be previously stored in the storage unit 501 or may be downloaded via a communication IF from a web server or the like operated by the service provider. The application program 5012 includes an interpreter programming language, such as JavaScript®, executed on a web browser application stored in the customer terminal 50.

### <Configuration of Control Unit of Customer Terminal 50>

The control unit 504 of the customer terminal 50 comprises an input control unit 5041 and an output control unit 5042. The control unit 504 implements the input control unit 5041 and the output control unit 5042, which are the functional units thereof, by executing the application program 5012 stored in the storage unit 501.

The input control unit 5041 of the customer terminal 50 obtains details of an operation of the touch-sensitive device 5061 of the touch panel 506 by the user, an audio input to the microphone 5081, or information output from the input devices, such as the position information sensor 5083, the camera 5084 or the motion sensor 5085, and performs various kinds of processing.

The output control unit 5042 of the customer terminal 50 receives an operation of the input devices by the user and information from the server 10, and performs control processing for the content to be displayed on the display 5062 and the content to be audibly output by the speaker 5082.

### <Operation of Information Processing System 1>

In the following, processing by the information processing system 1 will be described.

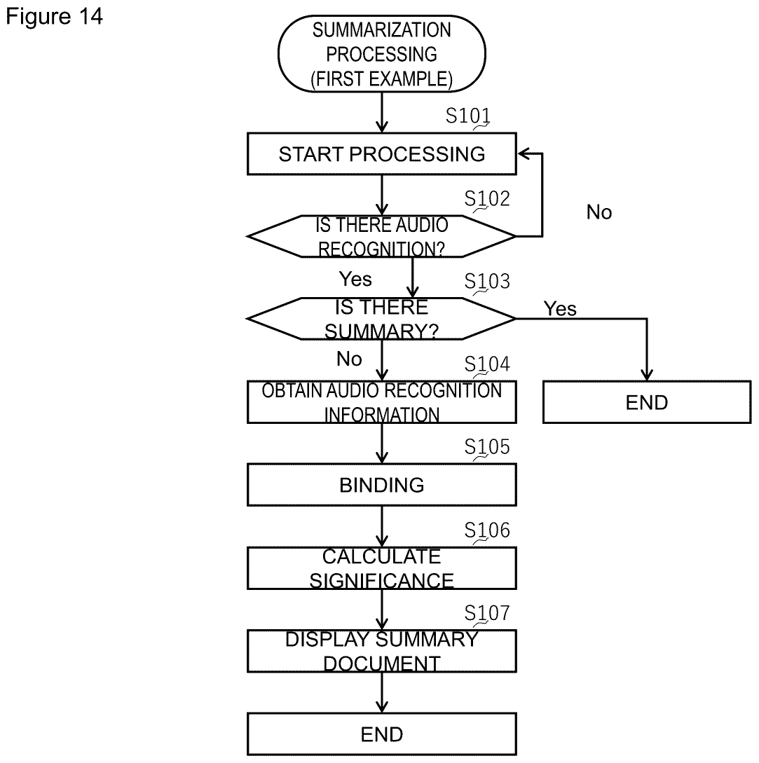

FIG. 14 is a flowchart showing an operation of summarization processing (first example).

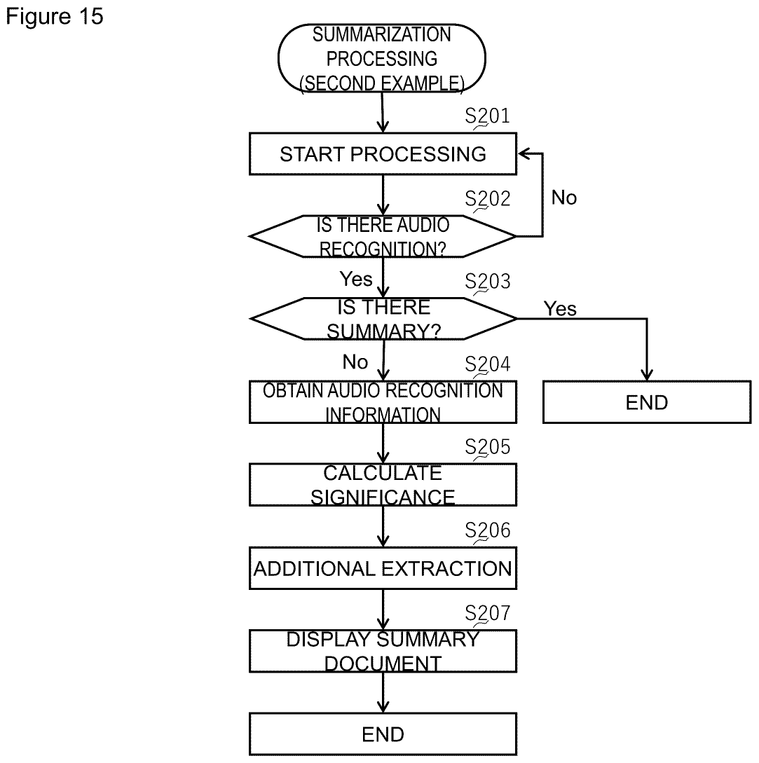

FIG. 15 is a flowchart showing an operation of summarization processing (second example).

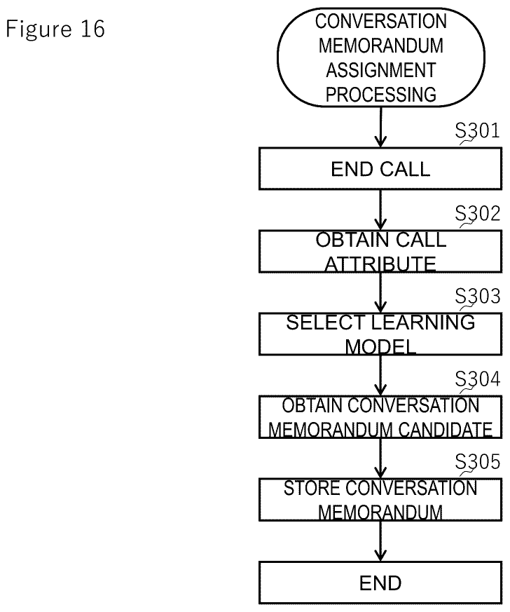

FIG. 16 is a flowchart showing an operation of conversation memorandum assignment processing.

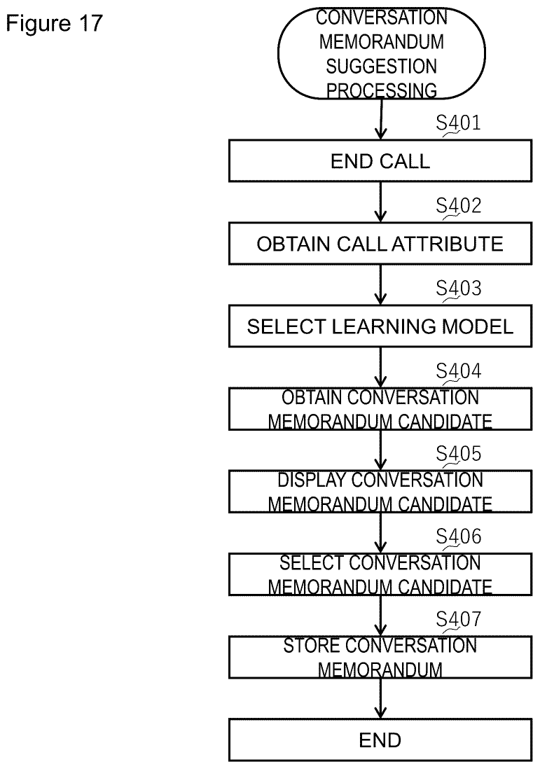

FIG. 17 is a flowchart showing an operation of conversation memorandum suggestion processing.

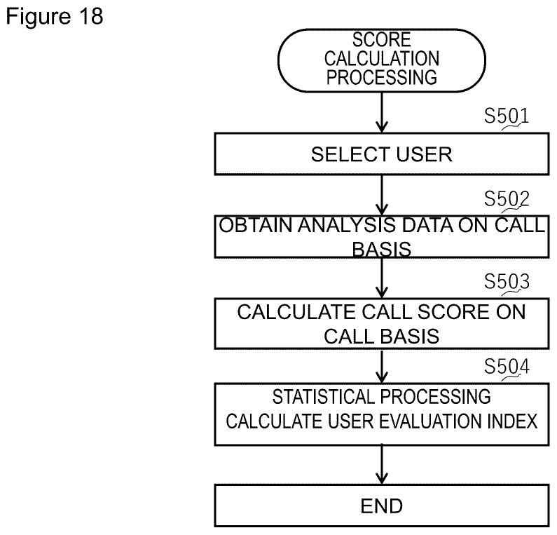

FIG. 18 is a flowchart showing an operation of score calculation processing.

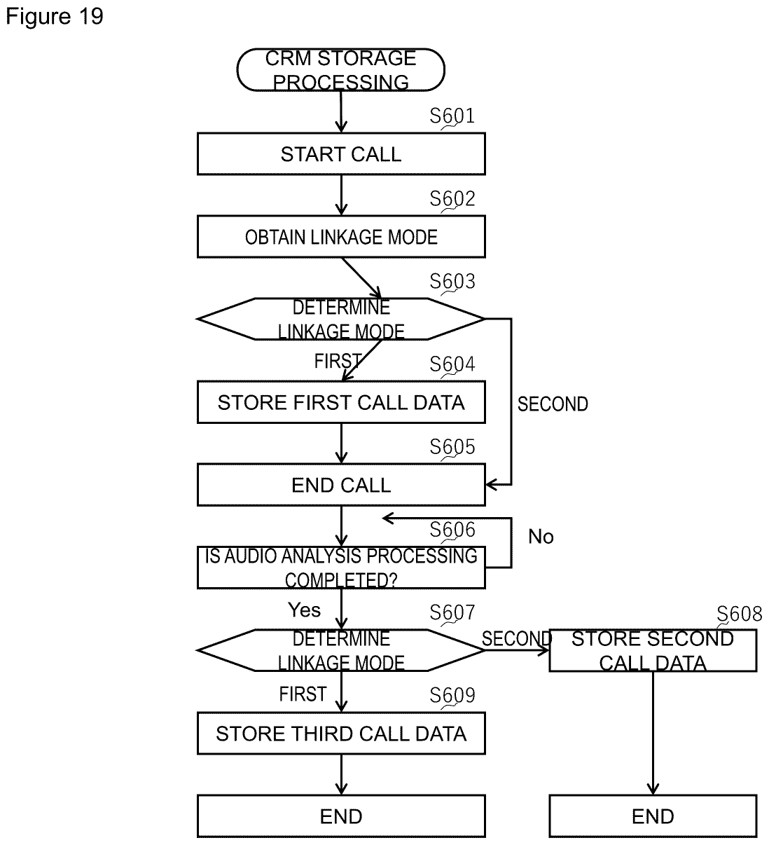

FIG. 19 is a flowchart showing an operation of CRM storage processing.

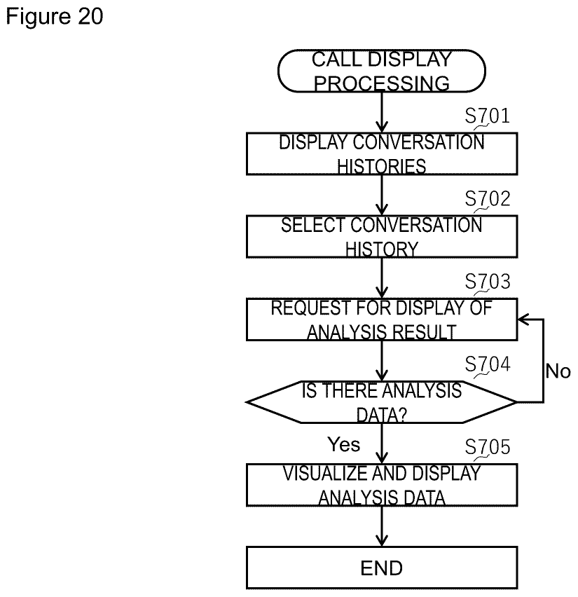

FIG. 20 is a flowchart showing an operation of call display processing.

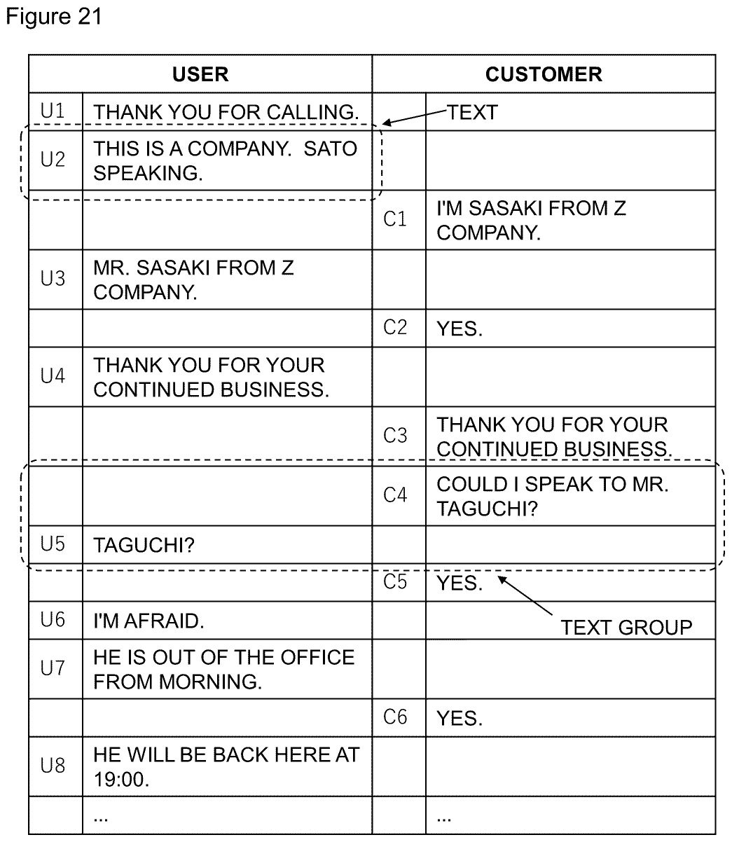

FIG. 21 is a diagram showing an overview of binding processing in the summarization processing (first example).

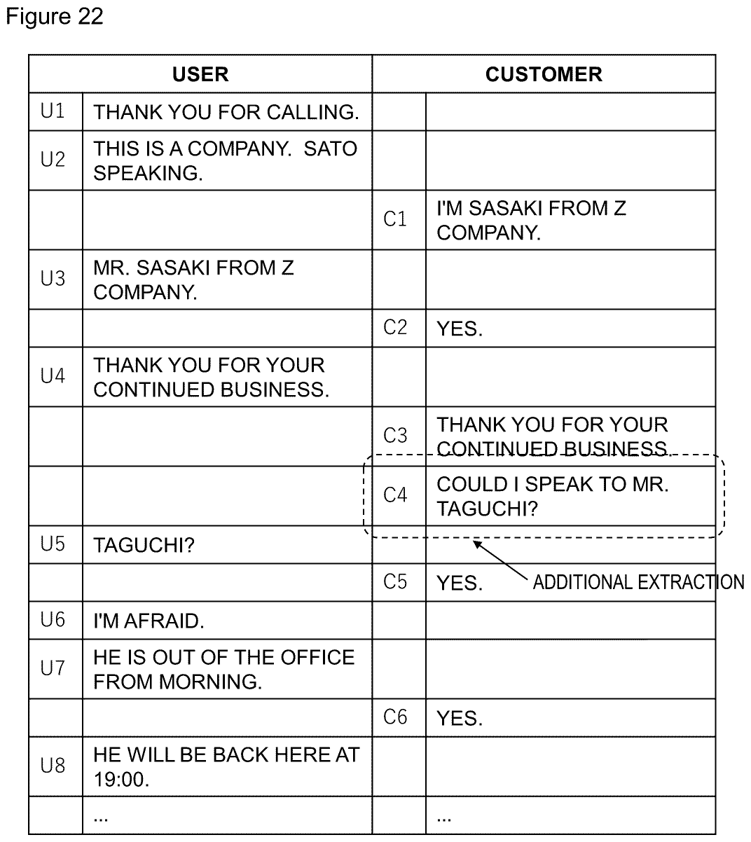

FIG. 22 is a diagram showing an overview of additional extraction processing in the summarization processing (second example).

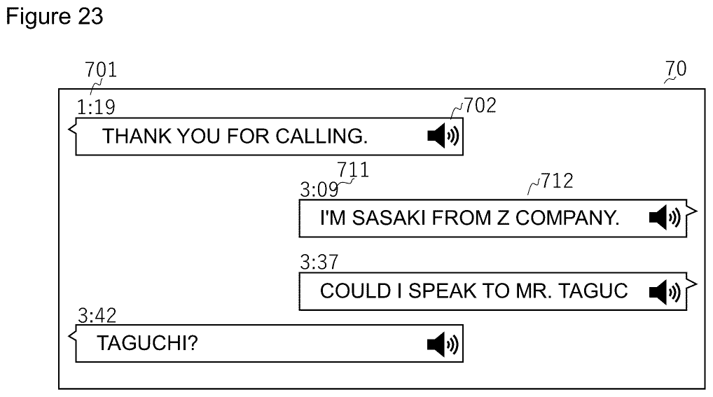

FIG. 23 is a diagram showing an overview of summary display processing.

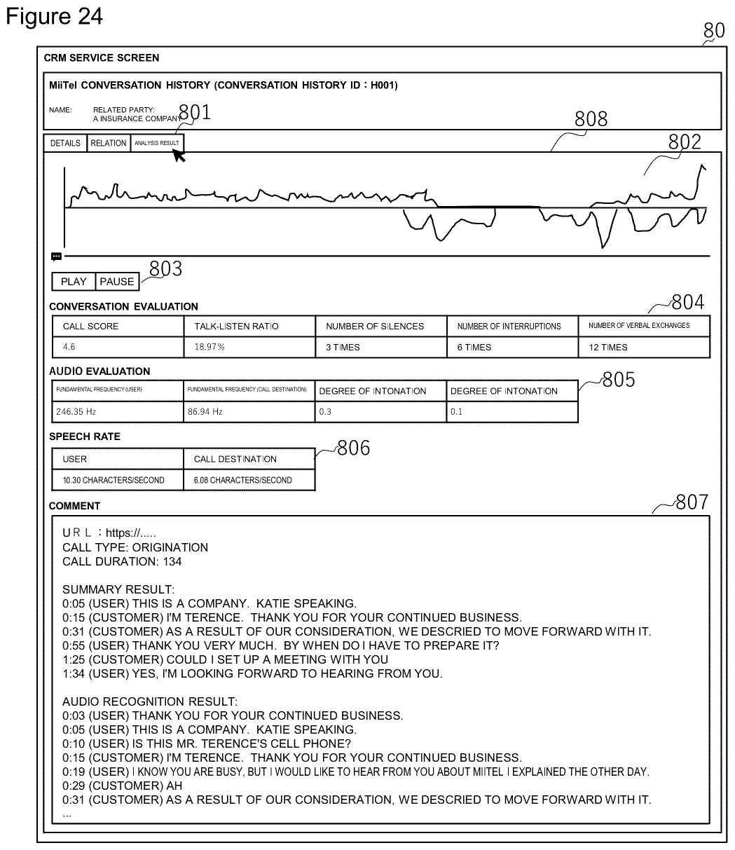

FIG. 24 is a diagram showing an example of a CRM service screen in the call display processing.

### Definitions of Terms

Before describing the processing by the information processing system 1, terms will be defined below.

The call data is data concerning a call between the user and the customer, and includes data stored in the items of the call table 1014, data stored in the items of the audio recognition table 1015 linked by the call ID, and data stored in the items of the summary table 1016 linked by the call ID, for example. The call data also includes data stored in the items of the conversation memorandum table 1017 and conversation history table 3013 linked by the call ID.

The call attribute is data concerning an attribute of the call between the user and the customer, and includes the user attribute, the organization name or organization attribute of the organization to which the user belongs, the customer attribute, the organization name or organization attribute of the organization to which the customer belongs, the call category, and the receiver/originator, for example. That is, the call data is characterized by attribute values including the user attribute of the user involved with the call, the customer attribute of the customer involved with the call, the call category of the call, and the receiver/originator.

### <Origination Processing>

Origination processing is processing in which the user originates a call (makes a call) to the customer.

### <Overview of Origination Processing>

The origination processing is a procedure in which the user originates a call to a customer by selecting a customer to which the user wants to originate a call from a plurality of customers displayed on the screen of the user terminal 20 and performing an origination operation.

### <Details of Origination Processing>

The origination processing of the information processing system 1 in the case where the user originates a call to the customer will be described.

When the user originates a call to the customer, the information processing system 1 performs the following processing.

The user operates the user terminal 20 to activate the web browser and access the website of the CRM service provided by the CRM system 30. The user can display a list of customers of the user on the display 2081 of the user terminal 20 by opening a customer management screen provided by the CRM service.

Specifically, the user terminal 20 transmits a request for display of the CRM ID 2013 and a list of customers to the CRM system 30. In response to receiving the request, the CRM system 30 searches the customer table 3012 and transmits information about the customer of the user, such as customer ID, name, telephone number, customer attribute, customer organization name and customer organization attribute, to the user terminal 20. The user terminal 20 displays the received information about the customers on the display 2081 of the user terminal 20.

The user selects, by pressing, a customer to whom the user wants to originate a call from the list of customers displayed on the display 2081. In the state where the customer is selected, the user presses an “originate” button or telephone number buttons displayed on the display 2081 of the user terminal 20, thereby transmitting a request including the telephone number to the CRM system 30. In response to receiving the request, the CRM system 30 transmits the request including the telephone number to the server 10. In response to receiving the request, the server 10 transmits an origination request to the audio server (PBX) 40. In response to receiving the origination request, the audio server (PBX) 40 originates a call (calls) the customer terminal 50 based on the received telephone number.

In response to this, the user terminal 20 controls the speaker 2082 or the like to sound or vibrate to indicate that the audio server (PBX) 40 is originating a call (calling). In addition, the display 2081 of the user terminal 20 displays information to the effect that the audio server (PBX) 40 is originating a call to (calling) the customer. For example, the display 2081 of the user terminal 20 may display a word “calling”.

The customer terminal 50 is enabled to communicate when the customer lifts a handset (not shown) of the customer terminal 50 or presses a “receive” button displayed on the touch panel 506 of the customer terminal 50 when an incoming call is being received. In response to this, the audio server (PBX) 40 transmits information that indicates that the customer terminal 50 has responded (referred to as a “response event”, hereinafter) to the user terminal 20 via the server 10, the CRM system 30 and the like.

In this way, the user terminal 20 of the user and the customer terminal 50 of the customer are ready to talk, and the user and the customer can talk to each other. Specifically, the voice of the user collected by the microphone 2062 of the user terminal 20 is output from the speaker 5082 of the customer terminal 50. Similarly, the voice of the customer collected by the microphone 5081 of the customer terminal 50 is output from the speaker 2082 of the user terminal 20.

Once the user terminal 20 and the customer terminal 50 are ready to talk, the display 2081 of the user terminal 20 receives the response event and displays information that indicates that a call has been established. For example, the display 2081 of the user terminal 20 may display a word “responding”.

Once the user terminal 20 and the customer terminal 50 are ready to talk, the call storage processing and the CRM storage processing described later are performed.

### <Reception Processing>

Reception processing is processing in which the user receives a (incoming) call from the customer.

### <Overview of Reception Processing>

The reception processing is a procedure in which the user receives a call when the customer originates the call to the user when the user has activated the application on the user terminal 20.

### <Details of Reception Processing>

The reception processing of the information processing system 1 in the case where the user receives a (incoming) call from the customer will be described.

When the user receives a call from the customer, the information processing system 1 performs the following processing.

The user operates the user terminal 20 to activate the web browser and access the website of the CRM service provided by the CRM system 30. In this process, the user logs in the CRM system 30 with the account of the user on the web browser and waits. Once the user has logged in the CRM system 30, the user may perform other tasks concerning the CRM service.

The customer operates the customer terminal 50 to input a predetermined telephone number assigned to the audio server (PBX) 40 and originate a call to the audio server (PBX) 40. The audio server (PBX) 40 receives the call originated by the customer terminal 50 as a reception event.

The audio server (PBX) 40 transmits the reception event to the server 10. Specifically, the audio server (PBX) 40 transmits a call reception request including the telephone number 5011 of the customer to the server 10. The server 10 transmits the call reception request to the user terminal 20 via the CRM system 30.

In response to this, the user terminal 20 controls the speaker 2082 or the like to sound or vibrate to indicate that the audio server (PBX) 40 is receiving a call. The display 2081 of the user terminal 20 displays information to the effect that the audio server (PBX) 40 is receiving a call from the customer. For example, the display 2081 of the user terminal 20 may display a word “call receiving”.

The user terminal 20 receives a response operation from the user. For example, the response operation is an operation of lifting a handset (not shown) of the user terminal 20 or an operation of the user operating the mouse 2066 to press a button “answer” displayed on the display 2081 of the user terminal 20.

In response to receiving the response operation, the user terminal 20 transmits a response request to the audio server (PBX) 40 via the CRM system and the server 10. The audio server (PBX) 40 receives the transmitted response request and establishes an audio communication. In this way, the user terminal 20 and the customer terminal 50 are ready to talk.

The display 2081 of the user terminal 20 displays information that indicates a call has been established. For example, the display 2081 of the user terminal 20 may display a word “on a call”.

Once the user terminal 20 and the customer terminal 50 are ready to talk, the call storage processing and the CRM storage processing described later are performed.

### <Call Storage Processing>

Call storage processing is processing of storing data concerning a call between the user and the customer.

### <Overview of Call Storage Processing>

The call storage processing is a procedure of storing data concerning a call in the call table 1014 when a call between the user and the customer is started.

### <Details of Call Storage Processing>

Once a call is started between the user and the customer, the audio server (PBX) 40 records audio data concerning the call between the user and the customer, and transmits the audio data to the server 10. In response to receiving the audio data, the control unit 104 of the server 10 creates a new record in the call table 1014, and stores data concerning the call between the user and the customer. Specifically, the control unit 104 of the server 10 stores the user ID, the customer ID, the call category, the reception/origination and the content of the audio data.

The control unit 104 of the server 10 obtains the user ID 2011 of the user from the user terminal 20 in the origination processing or reception processing and stores the user ID 2011 in the item of user ID of the new record.

The control unit 104 of the server 10 inquires of the CRM system 30 based on the telephone number in the origination processing or reception processing. The CRM system 30 searches the customer table 3012 based on the telephone number to obtain the customer ID, and transmits the customer ID to the server 10. The control unit 104 of the server 10 stores the obtained customer ID in the item of customer ID of the new record.

The control unit 104 of the server 10 stores a value of the call category, which is previously set for each customer, in the item of call category of the new record. The call category may be stored by the user selecting or inputting a value for each call.

The control unit 104 of the server 10 distinguishes whether the current call is originated by the user or by the customer, and stores a value representing outbound (when the call is originated by the user) or a value representing inbound (when the call is originated by the customer) in the item of reception/origination of the new record.

The control unit 104 of the server 10 stores the audio data received from the audio server (PBX) 40 in the item of audio data of the new record. The audio data may be stored as an audio data file at another place, and reference information (pass) for the audio data file may be stored in the item of audio data after the end of the call. The control unit 104 of the server 10 may be configured to store the data after the end of the call.

### <Audio Recognition Processing>

The audio recognition processing is processing of converting the audio data of the call between the user and the customer into text information through text recognition and storing the text information.

### <Overview of Audio Recognition Processing>

The audio recognition processing is a procedure of extracting sectional audio data by dividing the audio data stored in the call table 1014 into sections (speech sections) that contain audio, generating audio recognition information by performing text recognition on each piece of sectional audio data, and storing the audio recognition information in the audio recognition table 1015.

### <Details of Audio Recognition Processing>

The recognition unit 1043 of the server 10 searches the call table 1014 for a record that has been subjected to the call storage processing but has not been subjected to the audio recognition processing. Specifically, the recognition unit 1043 of the server 10 searches the call table 1014 for a record having a blank, a null or other information indicating that the audio recognition processing has not been performed stored in the item of presence/absence of audio recognition. The recognition unit 1043 of the server 10 may determine a record that has audio data stored in the call table 1014 but has no call ID included in the audio recognition table 1015 to be a record that has not been subjected to the audio recognition processing.

The recognition unit 1043 of the server 10 obtains (receives) the call ID and the audio data of the record that has not been subjected to the audio recognition processing. The recognition unit 1043 of the server 10 detects a section (speech section) that contains audio from the obtained (received) audio data, and extracts audio data from each speech section as sectional audio data. The sectional audio data is linked with the speaker and the time of speech for each speech section.

The recognition unit 1043 of the server 10 converts the sectional audio data into characters (text) (transcribes the sectional audio data) by performing text recognition on the extracted sectional audio data. The method of text recognition is not particularly limited. For example, the conversion may be achieved by machine learning or deep learning using the artificial intelligence (AI).

The recognition unit 1043 of the server 10 stores, in the audio recognition table 1015, a series of data obtained by linking the text of each speech section with the time of start of the speech section and the speaker (user or customer) after linking the series of data with the call ID involved with the processing. The recognition unit 1043 of the server 10 stores information that indicates that the audio recognition processing is completed in the item of presence/absence of audio recognition of the call table 1014.

The text of each speech section of the audio data is stored in the audio recognition table 1015 in the form of a series of time-series data linked with the time of speech and the speaker. By checking the data stored in the audio recognition table 1015, the user can check the content of the call in the form of text information even if the user does not listen to the content of the audio data.

The time of speech can be any time associated with the speech section, such as the time of start of the speech section, the time of end of the speech section or any point in time in the speech section.

### <Variation of Audio Recognition Processing>

In the audio recognition processing, the audio recognition information may be stored in the audio recognition table 1015 after information that is included in the text and is insignificant for grasping the call between the user and the customer, such as fillers, is omitted from the text.

### <Audio Analysis Processing>

The audio analysis processing is processing of analyzing the audio data of the call between the user and the customer to generate analysis data and storing the analysis data.

### <Overview of Audio Analysis Processing>

The audio analysis processing is a procedure of performing audio analysis processing on the audio data stored in the call table 1014 to generate analysis data and storing the analysis data in the call table 1014.

### <Details of Audio Analysis Processing>

The analysis unit 1044 of the server 10 searches the call table 1014 for a record that has been subjected to the call storage processing but has not been subjected to the audio analysis processing. Specifically, the analysis unit 1044 of the server 10 searches the call table 1014 for a record that has audio data stored but has no analysis data stored. That the analysis data is not stored means that a blank, a null or other information indicating that no analysis data is stored is stored in the item of analysis data.

Alternatively, information indicating that a record is a target of the audio analysis processing may be stored in a column not shown, and any record storing the information may be regarded as a target of the audio analysis processing.

The server 10 obtains the call ID and audio data of the record that has not been subjected to the audio analysis processing. The analysis unit 1044 of the server 10 analyzes the obtained audio data and calculates the talk-to-listen ratio, the number of silences, the number of interruptions, the number of verbal exchanges, the fundamental frequency, the change in intonation, the speech rate, the speech rate ratio, the number of fillers or the degree of adherence to a talk script, for example. The method of analysis is not particularly limited. For example, the analysis may be achieved by machine learning or deep learning using the artificial intelligence (AI).

The talk-to-listen ratio is a ratio between the speech duration of the user and the speech duration of the person on the other end.

The number of silences is the number of silences that occur during the call. The number of interruptions is the number of interruptions that occur during the call.

The number of verbal exchanges is the number of exchanges between the user and the customer (the number of changes of speakers) during the call.

The fundamental frequency is information corresponding to the fundamental frequency or, in other words, pitch of the voice of the user or customer, and the information is defined for each user and for each customer.

The change in intonation is information indicating the degree of intonation of the user or customer quantitatively evaluated, and the information is defined for each user and for each customer.

The speech rate is the speed at which the user or customer talks, and the information is defined for each user and for each customer. For example, the speech rate is indicated by the number of characters (or words) uttered per second.

The speech rate ratio is information about the ratio of speech rate between the user and the customer. Specifically, the speech rate ratio is indicated as a numeric value obtained by dividing the speech rate of the user by the speech rate of the customer. For example, the greater the value, the higher the speech rate of the user is compared with the customer.

The number of fillers is the number of fillers (such as um or ah) detected in the text of the audio recognition data. The number of fillers may be defined for each user or for each customer.

The degree of adherence to a talk script is information about the degree of adherence of the content of the statement of the user detected from the audio recognition data to a talk script set for each user or each organization to which the user belongs.

The analysis unit 1044 of the server 10 stores the analysis data in the item of analysis data of the current record in the call table 1014.

### <Summarization Processing (First Example)>

The summarization processing (first example) is processing of generating summary information from the audio recognition information and storing the summary information. In the following, details of the summarization processing (first example) will be described with reference to the flowchart of FIG. 14.

### <Overview of Summarization Processing (First Example)>

The summarization processing (first example) is a procedure of obtaining the audio recognition information stored in the audio recognition table 1015, performing binding processing of binding texts preceding and following a change of speakers into a text group once texts included in the audio recognition information are arranged in the order of time of speech, calculating the significance for the texts and text group after the binding processing, extracting a text used for a summary document based on the significance, generating the summary document and storing the summary document in the server 10 and the CRM system 30.

### <Details of Summarization Processing (First Example)>

The summarization unit 1046 of the server 10 regularly automatically perform the summarization processing (first example).

In Step S101, the summarization unit 1046 of the server 10 regularly starts the summarization processing (first example). The summarization unit 1046 of the server 10 may start the summarization processing (first example) when detecting the end of a call between the user and the customer.

In Step S102, the summarization unit 1046 of the server 10 refers to the call table 1014, and searches for a record having information indicating that the audio recognition processing is completed stored in the item of presence/absence of audio recognition. When a record having the information indicating that the audio recognition processing is completed stored is found, the summarization unit 1046 of the server 10 obtains the record and proceeds to Step S103 (Yes in Step S102).

In the period after the call between the user and the customer ends and before the audio recognition processing is completed, the information indicating the audio recognition processing is completed is not stored in the item of presence/absence of audio recognition of the record in the call table 1014, and therefore, the summarization unit of the server 10 waits in Step S102 (No in Step S102).

In Step S103, the summarization unit 1046 of the server 10 searches the records obtained in Step S102 for a record having a blank, a null or other information indicating the summarization processing (first example) has not been performed stored in the item of presence/absence of summary. The summarization unit 1046 of the server 10 may determine a record that has audio data stored in the call table 1014 but has no call ID included in the summary table 1016 to be a record that has not been subjected to the summarization processing (first example).

When a record that has not been subjected to the summarization processing (first example) is found, the summarization unit 1046 of the server 10 obtains the record and proceeds to Step S104 (Yes in Step S102).

In Step S104, the summarization unit 1046 of the server 10 searches the audio recognition table 1015 based on the call ID of the record that has not been subjected to the summarization processing (first example) to obtain audio recognition information including texts, times of speech and speakers.

In Step S105, the summarization unit 1046 of the server 10 performs binding processing on the obtained audio recognition information. Specifically, texts included in the audio recognition information are arranged in the order of time of speech, and a plurality of texts preceding and following a change of speaker information are bound to generate a text group. The text group is a data structure, such as a sequence, and is information including a plurality of texts of different speakers. The text group may include other audio recognition information, such as the times of speech or the speakers.

FIG. 21 is a diagram showing an overview of the binding processing in the summarization processing (first example), in which texts of each speaker are arranged from top to bottom in the order of time of speech. Texts of the user and the customer recognized in the speech sections are denoted by identification numbers U1, U2, . . . and C1, C2, . . . , respectively. For example, the summarization unit 1046 of the server 10 binds texts C4 and U5, between which the speaker information changes from customer to user, to generate a text group.

Although one text of the user and one text of the customer are bound to generate a text group in the present disclosure, two or more texts preceding and following a change in the speaker information may be bound to generate a text group. The significance may be previously calculated for texts (such as C4 and U5) preceding and following a change in the speaker information, and a number of texts depending on the value of the significance may be bound to generate a text group. For example, the higher the significance, a larger number of texts may be bound to generate a text group.

In a conversation among three or more speakers, similarly, a plurality of texts preceding and following a change in the speaker information may be bound to generate a text group.

In Step S106, the significance calculation unit 1045 of the server 10 performs significance calculation processing on texts or text groups. The method of significance calculation can use any significant sentence extraction algorithm.

In the present disclosure, a method of significance calculation according to an algorithm referred to as LexRank will be described, for example. LexRank is an algorithm in which a plurality of sentences are input, and each input sentence is divided into words through morphological analysis, a similarity (such as cosine similarity) between the sentences is calculated, a graph structure is calculated based on the similarity between the sentences, and the significance is calculated for each sentence based on the graph structure.

Specifically, the significance calculation unit 1045 of the server 10 calculates the significance of each text and each text group by applying LexRank by regarding each text and each text group as one input sentence.

### <Significance Calculation Processing (First Example)>

In the significance calculation processing (first example), the significance calculation unit 1045 of the server 10 applies LexRank by regarding a text generated by binding a plurality of texts included in a text group as one sentence. For example, the significance is calculated by applying LexRank by regarding a sentence “May I talk to Mr. Taguchi? Mr. Taguchi?” generated by binding the text C4 “May I talk to Mr. Taguchi?” and the text U5 “Mr. Taguchi?” as one sentence.

### <Significance Calculation Processing (Second Example)>

In the significance calculation processing (second example), the significance calculation unit 1045 of the server 10 applies LexRank by regarding each of a plurality of texts included in a text group as an independent sentence. The significance calculation unit 1045 of the server 10 performs processing of determining a sum of the significance values calculated for the independent sentences as the significance of the text group.

For example, the significance calculation unit 1045 of the server 10 applies LexRank to each of the sentences C4 and U5 included in the text group and calculates the significance for each of C4 and U5. The significance calculation unit 1045 of the server 10 then performs processing of determining a sum of the significance of C4 and the significance of U5 as the significance of the text group.

Alternatively, a statistical value (such as average, median, mode, maximum or minimum) obtained by performing statistical processing on the significance values calculated for the independent sentences may be used as the significance of the text group. Specifically, an average, maximum or the like of the significance values calculated for the independent sentences is preferably used as the significance of the text group.

In Step S107, the summarization unit 1046 of the server 10 extracts a text or text group the calculated significance of which is equal to or higher than a predetermined value. The summarization unit 1046 of the server 10 stores the extracted texts or the texts included in the extracted text group in the summary table 1016 along with the time of speech and speaker of each text in the audio recognition table 1015. In this way, summary information is stored in the summary table 1016. The summarization unit 1046 of the server 10 stores information indicating that the summarization processing (first example) is completed in the item of presence/absence of summary in the call table 1014.

The summarization unit 1046 of the server 10 combines the extracted texts or the texts included in the extracted text group into one sentence (summary text) along with the time of speech and speaker of each text in the audio recognition table 1015, generates a request including the call ID and the summary text, and transmits the request to the CRM system 30.

In response to receiving the request, the CRM system 30 searches the conversation history table 3013 based on the call ID included in the request, and stores the received summary text in the item of comment of the record having the call ID.

### <Summarization Processing (Second Example)>

The summarization processing (second example) is a second embodiment of the processing of generating summary information from audio recognition information and storing the summary information. In the following, details of the summarization processing (second example) will be described with reference to the flowchart of FIG. 15.

### <Overview of Summarization Processing (Second Example)>

The summarization processing (second example) is a procedure of obtaining audio recognition information stored in the audio recognition table 1015, calculating the significance for texts included in the audio recognition information, extracting texts used for a summary document based on the significance, extracting texts preceding and following a change of speakers from the extracted texts as texts used for a summary document once the texts included in the audio recognition information are arranged in the order of time of speech, generating a summary document and storing the summary document in the server 10 and the CRM system 30.

### <Details of Summarization Processing (Second Example)>

The process from Step S201 to Step S204 is the same as the process from Step S101 to Step S104 of the summarization processing (first example), and therefore descriptions thereof will be omitted.

In Step S205, the significance calculation unit 1045 of the server 10 performs significance calculation processing on the obtained audio recognition information. In the present disclosure, although the method of significance calculation can use any significant sentence extraction algorithm, a method of significance calculation according to the algorithm referred to as LexRank will be described, as with the summarization processing (second example), for example.

### <Significance Calculation Processing (Third Example)>

The significance calculation unit 1045 of the server 10 applies LexRank by regarding the texts included in the obtained audio recognition information as one sentence. FIG. 22 is a diagram showing an overview of additional extraction processing in the summarization processing (second example), in which texts of each speaker are arranged from top to bottom in the order of time of speech. In the example shown in FIG. 22, the significance is calculated for all the texts U1 to U8 and C1 to C6.

In Step S206, the summarization unit 1046 of the server 10 extracts a text the calculated significance of which is equal to or higher than a predetermined value. The summarization unit 1046 of the server 10 additionally extracts a text that differs in speaker from the extracted text and precedes or follows the extracted text in the order of time of speech.

For example, when the text U5 is extracted, the text C4, which differs in speaker from the text U5 and precedes the text U5 in the order of time of speech, is additionally extracted.

Although one text that differs in speaker from the extracted text and precedes or follows the extracted text in the order of time of speech is additionally extracted in the present disclosure, two or more texts may be additionally extracted. A number of texts depending on the value of the significance of the extracted text may be additionally extracted. For example, the higher the significance, a larger number of preceding or following texts that differ in speaker from the extracted text may be additionally extracted.

In a conversation among three or more speakers, similarly, a plurality of texts preceding and following a change in the speaker information may be additionally extracted.

The processing of Step S207 is the same as the processing of Step S107 of the summarization processing (first example), and therefore descriptions thereof will be omitted.

### <Variation of Summarization Processing>

In the summarization processing (first example) and summarization processing (second example), when calculating the significance of the text, the significance calculation unit 1045 of the server 10 may calculate the significance after omitting information that is included in the text and is insignificant for grasping the call between the user and the customer, such as fillers, from the text.

Similarly, in the summarization processing (first example) and summarization processing (second example), summary information may be stored in the summary table 1016 after omitting information that is included in the text and is insignificant for grasping the call between the user and the customer, such as fillers, from the text.

### <Summary Display Processing>

Summary display processing is processing of displaying summary information to the user in the form of a summary document. In the following, details of the summary display processing will be described with reference to the example screen in FIG. 23.

### <Overview of Summary Display Processing>

The summary display processing is a procedure of obtaining summary information stored in the summary table 1016, storing texts included in the summary information in speech bubbles differently colored for each speaker, arranging the texts in the order of time of speech, and displaying the texts in the form of a summary document on the display 2081 of the user terminal 20.

### <Details of Summary Display Processing>

The user logs in the server 10 and performs a predetermined operation to transmit, to the server 10, a request for displaying a list of a past call history between the user or a colleague of the user in the organization to which the user belongs and the customer. In response to receiving the request, the server 10 refers to the call table 1014 and transmits records of the past call history to the user terminal 20. The user terminal 20 displays the received records of the past call history in the form of a list on the display 2081 of the user terminal 20.

The user operates the user terminal 20 to select a call history record the summary information of which the user wants to check, and presses a summary display button or the like to transmit a request for display of a summary including the call ID relating to the selected call history to the server 10.

In response to receiving the request, the server 10 searches the summary table 1016 based on the call ID, and transmits summary information related with the call ID to the user terminal 20.

The user terminal 20 displays the received summary information as a summary document on the display 2081. The summary document displayed on the user terminal 20 will be described with reference to FIG. 23. The display 2081 of the user terminal 20 displays a summary display screen 70. In the summary display screen, the context (text) of a statement of the user is displayed in a speech bubble 702 along with a time of speech 701, and the content (text) of a statement of the customer is displayed in a speech bubble 712 along with a time of speech 711. The speech bubble 702 for displaying the content of a statement of the user has a tail facing left and can be distinguished from the speech bubble 712 for displaying the content of a statement of the customer, which has a tail facing right.

Based on the information about the texts, the times of speech and the speakers included in the obtained summary information, the display control unit 1052 of the user terminal 20 displays, from top to bottom in the order of time of speech, a list of texts of statements of the user in the speech bubbles 702 for displaying the content of a statement of the user and texts of statements of the customer in the speech bubbles 712 for displaying the content of a statement of the customer in a differentiable manner.

The color of the speech bubble 702 for displaying the content of a statement of the user is different from the color of the speech bubble 712 for displaying the content of a statement of the customer. This allows the user to visually recognize the speaker of each statement when checking the summary document. The colors of the speech bubbles 702 and 712 for displaying the content of a statement may be changed in at least one of lightness, hue, chroma and depth based on the significance of the text included in the statement content calculated in the summarization processing (first example) or summarization processing (second example). For example, the higher the significance of the text, the deeper the color of the speech bubble 702 or 712 including the text can be. This allows the user to visually recognize the significance of the content of each statement and quickly understand the content of the document when checking the summary document.

### <Audio Recognition Display Processing>

Audio recognition display processing is processing of displaying audio recognition information to the user in the form of an audio recognition document.

### <Overview of Audio Recognition Display Processing>

The audio recognition display processing is a procedure of obtaining audio recognition information stored in the audio recognition table 1015, storing texts included in the audio recognition information in speech bubbles color-coded on a speaker basis, arranging the texts in the order of time of speech, and displaying the texts as an audio recognition document on the display 2081 of the user terminal 20.

### <Details of Audio Recognition Display Processing>

The audio recognition display processing is basically the same as the summary display processing except that the audio recognition information is used instead of the summary information, that is, the audio recognition table 1015 is used instead of the summary table 1016, and therefore descriptions thereof will be omitted. In the audio recognition display processing, on an audio recognition display screen similar to the screen shown in FIG. 23, a list of audio recognition information is displayed in speech bubbles in such a manner that the speakers can be differentiated.

In the audio recognition display processing, the color of the speech bubble for displaying the content of a statement of the user is different from the color of the speech bubble for displaying the content of a statement of the customer. This allows the user to visually recognize the speaker of each statement when checking the audio recognition document. The colors of the speech bubbles for displaying the content of a statement may be changed in at least one of lightness, hue, chroma and depth based on the significance of the text included in the statement content calculated in the summarization processing (first example) or summarization processing (second example). For example, the higher the significance of the text, the deeper the color of the speech bubble including the text can be. This allows the user to visually recognize the significance of the content of each statement and quickly understand the content of the document when checking the audio recognition document. That is, even when the user checks all the audio recognition information on the call between the user and the customer, the user can visually and intuitively grasp only the content of a significant statement.

### <Conversation Memorandum Assignment Processing>

Conversation memorandum assignment processing is processing of automatically assigning conversation memorandum to a call between the user and the customer. In the following, details of the conversation memorandum assignment processing will be described with reference to the flowchart of FIG. 16.

### <Overview of Conversation Memorandum Assignment Processing>

The conversation memorandum assignment processing is a procedure of obtaining audio data concerning a call between the user and the customer, estimating a conversation memorandum candidate by applying a learning model to the audio data, and storing the estimated conversation memorandum candidate linked with call data concerning the call.

### <Details of Conversation Memorandum Assignment Processing>

In Step S301, the conversation memorandum assigning unit 1049 of the server 10 detects the end of a call between the user and the customer and starts the conversation memorandum assignment processing.

In Step S302, the conversation memorandum assigning unit 1049 of the server 10 obtains a call attribute of the call to be processed.

Specifically, the conversation memorandum assigning unit 1049 of the server 10 searches the call table 1014 based on the call ID of the call to be processed and obtains the call category and the reception/origination.

The conversation memorandum assigning unit 1049 of the server 10 searches the user table 1012 based on the user ID of the call to be processed and obtains the user attribute. The conversation memorandum assigning unit 1049 of the server 10 searches the organization table 1013 according to the organization ID stored in the user table 1012 based on the user ID of the call and obtains the organization name and the organization attribute of the organization to which the user belongs.

The conversation memorandum assigning unit 1049 of the server 10 inquires of the CRM system 30 based on the customer ID of the call to be processed, and obtains the customer attribute, the customer organization name and the customer organization attribute from the customer table 3012 of the CRM system 30.

The conversation memorandum assigning unit 1049 of the server 10 does not have to obtain all the call attributes and has only to obtain at least one of a plurality of call attributes as needed.

In Step S303, the conversation memorandum assigning unit 1049 of the server 10 selects a learning model based on the obtained call attributes. The learning model may be prepared for each call attribute or may be prepared for each set of a plurality of call attributes, such as a combination of the user attribute and the customer attribute.

The learning model can be any machine learning or deep learning model, and is trained with a data set created according to call attributes. The learning processing will be described in detail later.

In the present disclosure, a deep learning model will be described as an example of the learning model. The deep learning model can be any deep learning model that receives arbitrary time-series data as input data, such as Recurrent Neural Network (RNN), Long Short Term Memory (LSTM) or Gated Recurrent Unit (GRU). The learning model can be any deep learning model, such as Attention or Transformer.

In Step S304, the conversation memorandum assigning unit 1049 of the server 10 obtains audio data of the call to be processed, and uses the audio data as input data for the selected learning model, and a plurality of conversation memorandum candidates (a conversation memorandum group) and probability distributions are output (estimated) as output data.

Specifically, conversation memorandums “AAA”, “BBB”, “CCC” and the like are output along with probability distributions “0.6”, “0.3”, “0.1” and the like, respectively. The probability distribution may be normalized with a softmax function or the like or may not be normalized.

In Step S305, the conversation memorandum assigning unit 1049 of the server 10 stores a conversation memorandum candidate with the highest probability among the output conversation memorandum candidates in the item of memorandum content in the conversation memorandum table 1017 after linking the conversation memorandum candidate with the call ID of the call to be processed. In the item of date and time of assignment, the current date and time may be stored. In the item of assigner ID, information may be stored which indicates that the conversation memorandum was not assigned by the user and was automatically assigned by a system such as the server 10.

The conversation memorandum assigning unit 1049 of the server 10 may store a plurality of conversation memorandum candidates with probabilities equal to or higher than a predetermined value among the output conversation memorandum candidates in the item of memorandum content of the conversation memorandum table 1017.

### <Conversation Memorandum Assignment Processing (Variation)>

In Step S303, the conversation memorandum assigning unit 1049 of the server 10 may select a plurality of learning models based on a plurality of different call attributes. For example, the conversation memorandum assigning unit 1049 of the server 10 may select a first learning model prepared on a user attribute basis and a second learning model prepared on a customer attribute basis. In that case, the conversation memorandum assigning unit 1049 of the server 10 may select a plurality of learning models based on a plurality of arbitrary call attributes.

In Step S304, the conversation memorandum assigning unit 1049 of the server 10 obtains audio data of the call to be processed, and uses the audio data as input data for the plurality of selected learning models, and each learning model outputs (estimates) a plurality of conversation memorandum candidates and probability distributions as output data.

The conversation memorandum assigning unit 1049 of the server 10 can apply any operation to the probability distributions of the plurality of conversation memorandum candidates to calculate the probability distribution of each conversation memorandum candidate. For example, a sum or product of the probability distributions of a plurality of conversation memorandum candidates may be the probability distribution of the conversation memorandum candidates to be output.

Specifically, for conversation memorandums “AAA”, “BBB” and “CCC”, for example, when the probability distributions estimated by the first learning model are “0.6”, “0.3” and “0.1”, and the probability distributions estimated by the second learning model are “0.3”, “0.4” and “0.1”, the products thereof “0.18”, “0.12” and “0.01” may be the probability distributions of the conversation memorandums “AAA”, “BBB” and “CCC”. The probability distribution may be normalized with a softmax function or the like or may not be normalized.

### <Conversation Memorandum Suggestion Processing>

The conversation memorandum suggestion processing is processing of suggesting a conversation memorandum candidate to the user during a call between the user and the customer. In the following, details of the conversation memorandum assignment processing will be described with reference to the flowchart of FIG. 17.

### <Overview of Conversation Memorandum Suggestion Processing>

The conversation memorandum suggestion processing is a procedure of obtaining audio data concerning a call between the user and the customer, applying a learning model to the audio data to estimate conversation memorandum candidates, suggesting the estimated conversation memorandum candidates to the user, and storing a conversation memorandum candidate selected by the user after linking the conversation memorandum candidate with the call data concerning the call.

### <Details of Conversation Memorandum Suggestion Processing>

The process from Step S401 to Step S404 is the same as the process from Step S301 to Step S304 of the conversation memorandum assignment processing, and therefore descriptions thereof will be omitted.

In Step S405, the conversation memorandum suggestion unit 1048 of the server 10 transmits the output conversation memorandum candidates and probability distributions to the user terminal 20. The display 2081 of the user terminal 20 displays a list of the received conversation memorandum candidates so that the user can make a selection.

In this process, the user terminal 20 may regard the probabilities of the conversation memorandum candidates as priorities, and display a conversation memorandum candidate with a higher priority at a position where the conversation memorandum candidate is likely to be selected by the user on the display 2081 of the user terminal 20. For example, conversation memorandum candidates with higher priorities may be displayed at higher positions in the list, or when a plurality of conversation memorandum candidates are displayed in a carousel or page ejection mode, conversation memorandum candidates with higher priorities may be displayed on the top page.

That is, the user terminal 20 displays conversation memorandum candidates with higher probabilities at positions where the conversation memorandum candidates are likely to be selected by the user on the display 2081 of the user terminal 20. This allows the user to more accurately and easily select a probable conversation memorandum from a plurality of conversation memorandums.

In Step S406, the user selects one or more conversation memorandum candidates from the conversation memorandum candidates displayed on the display 2081 of the user terminal 20. The user transmits the selected conversation memorandum candidate(s) and the user ID 2011 to the server 10 by pressing a transmission button displayed on the display 2081 of the user terminal 20.

In Step S407, the conversation memorandum assigning unit 1049 of the server 10 stores the received conversation memorandum candidate(s) and user ID 2011 in the items of memorandum content and assigner ID of the conversation memorandum table 1017 after linking the conversation memorandum candidate(s) and user ID 2011 with the call ID of the call to be processed. The current date and time may be stored in the item of date and time of assignment.

### <Learning Processing>

The learning processing is processing of constructing a learning model used for the conversation memorandum assignment processing or the conversation memorandum suggestion processing, for example.

### <Overview of Learning Processing>

The learning processing is processing for training parameters of learning model that receives audio data concerning a call between the user and the customer as input data and provides a memorandum content linked with the audio data as output data (output vector).

### <Details of Learning Processing>

The learning unit 1047 of the server 10 searches the call table 1014 and refers to the conversation memorandum table 1017 based on the audio data and the call ID, thereby obtaining a memorandum content linked with the audio data. The learning unit 1047 of the server 10 divides the audio data according to the call attributes, and creates a data set, such as training data, test data or verification data, for each call attribute.

The learning unit 1047 of the server 10 trains the parameters of the learning model prepared for each call attribute using a data set for the call attribute.

The learning unit 1047 of the server 10 may omit audio data linked with a predetermined conversation memorandum. Specifically, when creating a data set, the learning unit 1047 of the server 10 omits audio data concerning a call assigned with a memorandum content indicating that the call is not substantially established between the user and the customer, such as “answering machine”, “customer (person in charge) unavailable” or “reception blocked by customer”. In this way, data that is unwanted for creation of the learning model for estimating memorandum contents is omitted from the data set, so that a more precise learning model can be created.

For example, the learning unit 1047 of the server 10 may create a data set for information concerning any one user attribute of the job category of the user involved with the call, the category of business of the organization to which the user belongs and the name of the organization to which the user belongs.

For example, the learning unit 1047 of the server 10 may create a data set for information concerning any one customer attribute of the job category of the customer involved with the call, the category of business of the organization to which the customer belongs and the name of the organization to which the customer belongs.

For example, the learning unit 1047 of the server 10 may create a data set for information concerning a call category of a call, such as telephone operator, telemarketing, customer support or technical support.

For example, the learning unit 1047 of the server 10 may create a data set for information concerning any of outbound, which means that the user originates a call to the customer, and inbound, which means that the user receives a call from the customer.

When training the learning model for each user attribute of the user involved with a call, the learning unit 1047 of the server 10 may use audio data subjected to the processing of extracting only the voice of the user (or, in other words, omitting the voice of the customer) as input data for the learning processing. In that case, the audio data to be used for the learning model in the estimation processing of Steps S304 and S404 of the conversation memorandum assignment processing and the conversation memorandum suggestion processing is also subjected to the processing of extracting only the voice of the user (omitting the voice of the customer) to obtain the input data.

By training the learning model for a user attribute based only on the content of statements of the user, a learning model that can more accurately estimate a conversation memorandum can be created.

When training the learning model for each customer attribute of the customer involved with a call, the learning unit 1047 of the server 10 may use audio data subjected to the processing of extracting only the voice of the customer (or, in other words, omitting the voice of the user) as input data for the learning processing. In that case, the audio data to be used for the learning model in the estimation processing of Steps S304 and S404 of the conversation memorandum assignment processing and the conversation memorandum suggestion processing is also subjected to the processing of extracting only the voice of the customer (omitting the voice of the user) to obtain the input data.

By training the learning model for a customer attribute based only on the content of statements of the customer, a learning model that can more accurately estimate a conversation memorandum can be created.

### <Variation of Learning Processing>

Although the audio data is used as input data for the learning model in the present disclosure, data obtained by converting the audio data through arbitrary information processing may be used as input data. For example, instead of the audio data, text data obtained by performing text recognition (transcription) on the audio data may be used as the input data. Alternatively, data obtained by converting the text data through arbitrary information processing may be used as the input data. In the present disclosure, applying a learning model to audio data includes applying a learning model to data obtained by converting audio data by performing arbitrary information processing on the audio data as described above.

In that case, when the learning model estimates the conversation memorandum candidates in the conversation memorandum assignment processing, the conversation memorandum suggestion processing or the like, the learning model can be applied after performing the same information processing on the audio data used as input data. For example, when the learning model estimates the conversation memorandum candidates in the conversation memorandum assignment processing or conversation memorandum suggestion processing, for example, text data obtained by performing text recognition (transcription) on the audio data can be used as input data, instead of the audio data.

### <Score Calculation Processing>

The score calculation processing is processing of calculating a call score for each user. In the following, details of the score calculation processing will be described with reference to the flowchart of FIG. 18.

### <Overview of Score Calculation Processing>

The score calculation processing is processing of calculating a call score of a user by performing analysis processing or statistical processing on the call data of the user. This allows evaluation of the customer conversation skills of the user based on a quantitative index.

### <Details of Score Calculation Processing>

In step S501, the user operates the user terminal 20 to transmit a request for a user list to the server 10. Based on the received request, the score calculation unit 1050 of the server 10 obtains a list of users who belong to the same organization (users who have the same organization ID) as the user having transmitted the request from the user table 1012 and transmits the list of users to the user terminal 20.

The display 2081 of the user terminal 20 displays the obtained list of users so that the user can make a selection. The user selects a user whose score the user wants to calculate from the list of users displayed on the display 2081 of the user terminal 20. The user transmits the user ID of the selected user to the server 10 by pressing a transmission button displayed on the display 2081 of the user terminal 20.

In Step S502, the score calculation unit 1050 of the server 10 searches the call table based on the received user ID to obtain analysis data of each call of the target user.

In this process, the score calculation unit 1050 of the server 10 may omit analysis data linked with a predetermined conversation memorandum. Specifically, when obtaining analysis data for each call of the target user, the score calculation unit 1050 of the server 10 obtains a memorandum content in the conversation memorandum table 1017 linked by the call ID of the call. The score calculation unit 1050 of the server 10 omits analysis data concerning a call assigned with a memorandum content indicating that the call is not substantially established between the user and the customer, such as “answering machine”, “customer (person in charge) unavailable” or “reception blocked by customer”. In this way, since a call that is not substantially established is omitted when calculating the call score of the target user, the call score can be more accurately calculated.

The score calculation unit 1050 of the server 10 calculates the call score by applying a predetermined algorithm to the analysis data of each call. Specifically, the score calculation unit 1050 of the server 10 calculates the call score by calculating a predetermined weighted sum based on the divergence of various index values (such as the number of silences, the number of interruptions and the number of verbal exchanges) included in the analysis data from the respective reference index values or the like. In this process, arbitrary processing, such as normalization, may be applied to the index values.

In Step S504, the score calculation unit 1050 of the server 10 calculates, as a user evaluation index of the target user, a statistical value (such as average, median, mode, maximum or minimum) by performing statistical processing on the call scores calculated based on the analysis data of the calls of the target user. Specifically, an average of the call scores calculated based on the analysis data of the calls of the target user is preferable as the user evaluation index.

The score calculation unit 1050 of the server 10 stores the calculated user evaluation index in the item of evaluation index of the record of the target user in the user table 1012. The score calculation unit 1050 of the server 10 transmits the calculated user evaluation index to the user terminal 20 of the user for which the score calculation processing has been performed. The display 2081 of the user terminal 20 displays the received user evaluation index of the target user to the user.

### <Linkage Mode Setting Processing>

The linkage mode setting processing is processing for setting storage processing for call information into the CRM system 30 before the call storage processing.

### <Overview of Linkage Mode Setting Processing>

The user or an administrator or the like of the organization or department to which the user belongs opens a predetermined website provided by the server 10, and brings up an editing screen for linkage mode setting. The user can set storage processing for the call information into the CRM system 30 in the server 10 by selecting a desired linkage mode in the linkage mode setting screen and performing a saving operation or the like.

The linkage mode setting does not have to be performed by the user, and a predefined value may be used for the linkage mode setting. The linkage mode may be set by the user when the user uses the audio call service according to the present disclosure for the first time.

### <Details of Linkage Mode Setting Processing>

The user or an administrator or the like (such as the user) of the organization or department to which the user belongs operates the user terminal 20 of their own to open the website relating to the editing screen for linkage mode setting provided by the server 10 via a web browser or the like. The user or the like operates the user terminal 20 to select any of a first mode and a second mode as a desired linkage mode in the linkage mode setting screen. The user or the like operates the user terminal 20 to transmit the user ID 2011 and the selected linkage mode to the server 10. The setting unit 1042 of the server 10 searches the user table 1012 based on the received user ID 2011, and stores the received linkage mode in the item of linkage mode of the record of the user.

The linkage mode may be stored for each of the organizations to which the users belong, rather than for each user. That is, the linkage mode is stored in the item of linkage mode set in the organization table 1013, and for the linkage mode of each user, the item of linkage mode of the organization table 1013 linked by the organization ID may be referred to.

### <CRM Storage Processing>

The CRM storage processing is processing for storing information about a call between the user and the customer using the audio call service according to the present disclosure in the CRM system 30. In the following, details of the CRM storage processing will be described with reference to the flowchart of FIG. 19.

### <Overview of CRM Storage Processing>

The CRM storage processing is a procedure of obtaining a linkage mode set for each user or organization and storing data concerning a call according to the set value of the linkage mode when the call is started between the user and the customer. In this way, the data concerning the call is linked with the customer information of the customer involved with the call and stored in the CRM system 30.

### <Details of CRM Storage Processing>

In Step S601, after origination processing or reception processing (reception/origination processing) is performed, a call is started between the user and the customer. In response to this, the server 10 detects the start of the call between the user and the customer.

In Step S602, the CRM storage control unit 1051 of the server 10 searches the user table 1012 based on the user ID 2011 received from the user terminal 20 to obtain the linkage mode of the user involved with the call. When the linkage mode is stored in the organization table 1013 or the like on an organization basis, the CRM storage control unit 1051 searches the organization table 1013 or the like based on the organization ID of the user, and regards the linkage mode linked with the user as the linkage mode of the user.

In Step S603, the CRM storage control unit 1051 of the server 10 determines whether the obtained linkage mode is the first mode or the second mode. When the obtained linkage mode is the first mode, the CRM storage control unit 1051 of the server 10 proceeds to Step S604. When the obtained linkage mode is the second mode, the CRM storage control unit 1051 of the server 10 skips Step S604 and proceeds to Step S605.

In Step S604, the CRM storage control unit 1051 of the server 10 transmits, to the CRM system 30, a request for storing first call data and call data including the call ID of the call in the call table 1014 in association with the customer ID. The first call data is data concerning the call that can be obtained after the call started until the call is ended.

Specifically, as the first call data, the CRM system 30 links the user ID of the user involved with the call, the customer ID of the customer involved with the call, the date and time of origination (only in the case of origination) and the date and time of start of the call with the call ID, and stores the user ID, the customer ID, the date and time of origination and the date and time of start of the call in the items of user ID, customer ID, date and time of dialing and date and time of start of a call of the conversation history table 3013, respectively. The first call data may be configured to include at least one of the user ID, the customer ID of the customer, the date and time of dialing and the date and time of start of a call.

In Step S605, the CRM storage control unit 1051 of the server 10 detects the end of the call between the user and the customer.

In Step S606, the CRM storage control unit 1051 of the server 10 determines whether or not the audio analysis processing on the call has been completed. Specifically, the CRM storage control unit 1051 of the server 10 refers to the call table 1014, and determines whether or not a blank, a null or other information indicating that the audio analysis processing has not been completed is stored in the item of analysis data of the record of the call.

When the audio analysis processing has not been completed, the CRM storage control unit 1051 of the server 10 waits in Step S606. When the audio analysis processing has been completed, the CRM storage control unit 1051 of the server 10 proceeds to Step S607.

In Step S607, the CRM storage control unit 1051 of the server 10 determines whether the obtained linkage mode is the first mode or the second mode. When the obtained linkage mode is the first mode, the CRM storage control unit 1051 of the server proceeds to Step S609. When the obtained linkage mode is the second mode, the CRM storage control unit 1051 of the server 10 proceeds to Step S608.

In Step S608, the CRM storage control unit 1051 of the server 10 transmits, to the CRM system 30, a request for storing second call data and call data including the call ID of the call in the call table 1014 in association with the customer ID. The second call data is data concerning the call that can obtained after the end of the call.

As the second call data, the CRM system 30 links the user ID of the user involved with the call, the customer ID of the customer involved with the call, the date and time of origination (only in the case of origination), the date and time of start of the call and the date and time of end of the call with the call ID, and stores the user ID, the customer ID, the date and time of origination, the date and time of start of the call and the date and time of end of the call in the items of user ID, customer ID, date and time of dialing, date and time of start of a call and date and time of end of a call of the conversation history table 3013, respectively. The CRM system 30 links the audio recognition information concerning the call and the summary information concerning the call with the call ID and stores the audio recognition information and the summary information in the item of comment of the conversation history table 3013. Specifically, as shown as an audio recognition result and a summary result in a comment 807 in FIG. 24, the audio recognition information and the summary information are converted into information in a text form including a combination of times of speech, speakers and texts and stored in the item of comment of the conversation history table 3013. The conversation history table 3013 may store only partial information of the second call data.

In Step S609, the CRM storage control unit 1051 of the server 10 transmits, to the CRM system 30, a request for storing third call data and call data including the call ID of the call in the call table 1014 in association with the customer ID. The third call data is data concerning the call that can be obtained after the end of the call from which data included in the first call data is omitted.

As the second call data, the CRM system 30 links the date and time of end of the call with the call ID and stores the date and time of end of the call in the item of date and time of end of a call of the conversation history table 3013. The CRM system 30 links the audio recognition information concerning the call and the summary information concerning the call with the call ID and adds the audio recognition information and the summary information to the item of comment of the conversation history table 3013. Specifically, as shown as the audio recognition result and the summary result in the comment 807 in FIG. 24, the audio recognition information and the summary information are converted into information in a text form including a combination of times of speech, speakers and texts and added to the item of comment of the conversation history table 3013.

In this step, when the linkage mode is the first mode, since a record has already been created in the conversation history table 3013 in Step S604, the CRM storage control unit 1051 of the server 10 adds the audio recognition information and the summary information in such a manner that the content already written in the comment of the record is not overwritten. Specifically, when the linkage mode is the first mode, a new record of the call may be created in the conversation history table 3013, and another user or the like may make an addition to the comment. In such a case, again, the CRM storage control unit 1051 of the server 10 makes an addition in such a manner that the comment of the record is not overwritten.

The CRM system 30 links an URL generated based on the call ID with the call ID and stores the URL in the item of URL of the conversation history table 3013. The conversation history table 3013 may store only partial information of the third call data.

### <Variation>

The server 10 may be configured to store customer information by obtaining customer information from the customer table 3012 or the like of the CRM system 30 and storing the customer information in a database or the like (not shown). In that case, the CRM storage control unit 1051 of the server 10 may transmit, to the CRM system 30, a request including the customer ID, the customer name, the customer organization name or the like instead of the call ID, thereby storing the call data in association with the customer involved with the call. In that case, again, the data concerning the call is linked with the customer information of the customer involved with the call and stored in the CRM system 30.

Although the server 10 provides a service concerning a call between the user and the customer in the present disclosure, the call service may be provided by an external service (not shown). In that case, the CRM storage control unit 1051 of the server 10 may detect the start of a call between the user and the customer and start the CRM storage processing in response to receiving a request concerning the start of the call between the user and the customer provided by the external service. Similarly, the CRM storage control unit 1051 of the server 10 may detect the end of a call between the user and the customer in response to receiving a request concerning the end of the call between the user and the customer provided by the external service. Alternatively, the end of a call between the user and the customer may be detected based on the audio data of the call between the user and the customer, such as in response to disappearance of the audio data.

### <Call Display Processing>

The call display processing is processing for displaying call data stored in the CRM system 30 to the user. In the following, details of the call display processing will be described with reference to the flowchart of FIG. 20. FIG. 24 is a diagram showing an example screen output by the CRM system 30 in the call display processing.

### <Overview of Call Display Processing>

After the call between the user and the customer ends, the user operates the user terminal 20 to bring up conversation histories with the customer stored in the CRM system 30. The user operates the user terminal 20 to select a conversation history the analysis data of which the user wants to bring up from the conversation histories with the customer and requests for display of the analysis data. Then, the CRM system 30 obtains the analysis data from the server 10, and displays the customer information and the analysis data on the display 2081 of the user terminal 20.

### <Details of Call Display Processing>

In Step S701, the user operates the user terminal 20 to open a predetermined website provided by the CRM system 30 and bring up a conversation history display screen.

Specifically, the user terminal 20 transmits a request concerning display of a list of customer information to the CRM system 30. The CRM system 30 searches the customer table 3012 and transmits a record to the user terminal 20. The display 2081 of the user terminal 20 displays the received customer information in a list form so that the user can make a selection.

The user selects a customer a conversation history of whom the user wants to bring up from the customer information displayed in a list form on the display 2081 of the user terminal 20, and transmits the customer ID of the selected customer to the CRM system 30 by pressing the “transmission” button. In response to receiving the customer ID, the CRM system 30 searches the conversation history table 3013 and transmits a record of a conversation history relating to the selected customer to the user terminal 20. The display 2081 of the user terminal 20 displays the received conversation history in a list form so that the user can make a selection.

In Step S702, the user selects a record a conversation history of which the user wants to bring up from the list of conversation histories displayed on the display 2081 of the user terminal 20, and transmits the conversation history ID of the selected conversation history to the CRM system 30 by pressing the “transmission” button. The CRM system 30 generates a display screen for the selected conversation history information and transmits the display screen to the user terminal 20. The display 2081 of the user terminal 20 displays the display screen for the received conversation history information. In the display screen for the conversation history information, the URL, the customer information, the user information, the date and time of dialing, the date and time of start of a call and the date and time of end of a call that are stored in the conversation history table 3013 and the audio recognition information and summary information stored in the comment in the CRM storage processing and the like are displayed.

The processing of Steps S701 and S702 does not have to be performed. For example, after the call between the user and the customer ends, the user terminal 20 may regard the conversation history concerning the call as the selected conversation history, and transmit the conversation history ID to the CRM system 30.

In Step S703, the user operates the user terminal 20 to press an “analysis result” button 801 displayed on the display screen for the conversation history information. The user terminal 20 transmits a request for display of an analysis result including the conversation history ID relating to the call to the CRM system 30. The CRM system 30 searches the conversation history table 3013 based on the received conversation history ID to determine the call ID. The CRM system 30 transmits a request for analysis data including the determined call ID to the server 10. The server 10 searches the call table 1014 based on the received call ID to check whether there is analysis data or not. When there is no analysis data, the server 10 waits in Step S703.

When there is analysis data, the server 10 proceeds to Step S704.

In Step S704, the server 10 searches the call table 1014 based on the received call ID, and transmits the analysis data to the CRM system 30. The CRM system 30 generates an analysis result screen 808 that visualizes the analysis data based on the received analysis data, and transmits the analysis result screen 808 to the user terminal 20. The analysis result screen 808 includes an audio analysis result 802, a conversation evaluation 804, an audio evaluation 805 and a speech rate 806 shown in FIG. 24. The analysis result screen 808 may include a comment 807, which is an audio recognition result and a summary result in a text form that are stored in the item of comment of the conversation history table 3013. The user can play call audio by pressing a play and stop button 803.

In the CRM system 30, information concerning the customer, such as the customer table 3012, is accumulated. The user can quickly grasp details of the conversation histories with the customer by selectively bringing up the information concerning the customer stored in the CRM system 30 or the analysis result screen that visualizes the analysis data or bringing up the information and the analysis result screen at the same time side by side.

### <Variation>

Although the audio server (PBX) 40 and the customer terminal 50 have been described as being connected to each other by the telephone network T in the present disclosure, the present disclosure is not limited thereto. That is, the audio server (PBX) 40 and the customer terminal 50 can be connected to each other by any communication means including the Internet, for example.

In that case, in the origination processing, a call may be originated (made) to the customer terminal 50 based on information for identifying the customer, such as any customer identification information or URL, rather than based on the telephone number of the customer. Similarly, in the call reception processing, the call reception request may include information for identifying the customer, such as any customer identification information or URL, and the (incoming) call may be received by the user terminal 20 determined based on the information, such as the customer identification information or URL.

### <Basic Hardware Configuration of Computer>

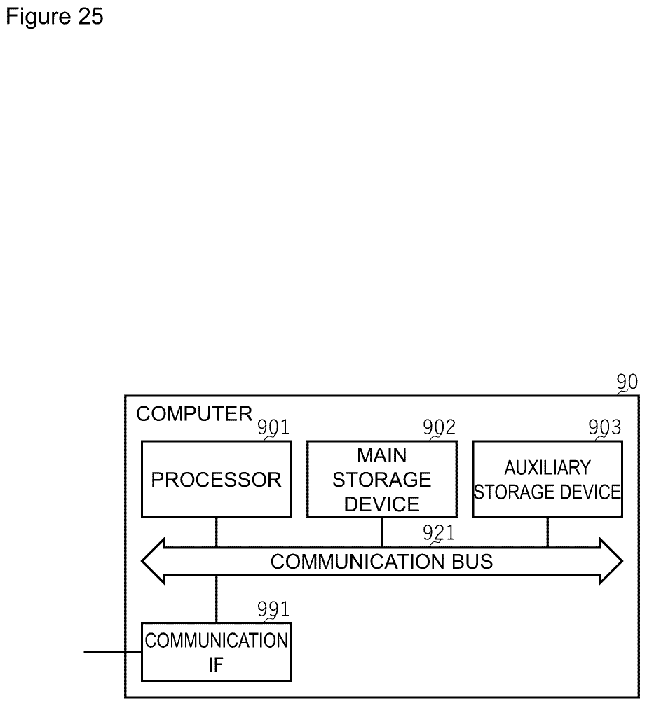

FIG. 25 is a block diagram showing a basic hardware configuration of a computer 90. The computer 90 comprises at least a processor 901, a main storage device 902, an auxiliary storage device 903 and a communication interface (IF) 991. The components are electrically interconnected by a communication bus 921.

The processor 901 is hardware for executing an instruction set described in a program. The processor 901 comprises an arithmetic device, a register, a peripheral circuit and the like.

The main storage device 902 is a storage device for temporarily storing a program and data processed by the program or the like, for example. For example, the main storage device 902 is a volatile memory, such as a dynamic random access memory (DRAM).

The auxiliary storage device 903 is a storage device for saving data and a program. For example, the auxiliary storage device 903 is a flash memory, a hard disk drive (HDD), a magneto-optical disk, a CD-ROM, a DVD-ROM or a semiconductor memory.

The communication IF 991 is an interface through which signals for communicating with another computer via a network are input and output according to a wired or wireless communication standard.

The network is formed by various mobile communication systems and the like formed by the Internet, LANs, radio base stations and the like. For example, the network includes a radio network (such as Wi-Fi®) that can connect to the Internet via a 3G, 4G or 5G mobile communication system, Long Term Evolution (LTE) or a predetermined access point. For wireless connection, the communication protocol may be Z-Wave®, ZigBee® or Bluetooth®, for example. When connecting by wire, the network also includes a direct connection, such as a universal serial bus (USB) cable.

All or part of the components of the hardware configuration may be distributed on a plurality of computers 90 and interconnected via a network, thereby implementing a virtual computer 90. That is, the computer 90 conceptually includes not only the computer 90 packaged in a single housing or case but also a virtualized computer system.

### <Basic Functional Configuration of Computer 90>

A functional configuration of the computer implemented by the basic hardware configuration (FIG. 25) of the computer 90 will be described. The computer comprises at least a control unit, a storage unit and a communication unit as functional units.

The functional units of the computer 90 may be implemented by distributing all or part of the functional units on a plurality of computers 90 interconnected via a network. The computer 90 conceptually includes not only a single computer 90 but also a virtualized computer system.

The control unit is implemented by the processor 901 reading various programs stored in the auxiliary storage device 903, deploying the programs in the main storage device 902 and performing processing according to the programs. The control unit can implement various functional units that perform various information processing according to the type of the program. Thus, the computer is implemented as an information processing device that performs information processing.

The storage unit is implemented by the main storage device 902 and the auxiliary storage device 903. The storage unit stores data, various programs and various databases. The processor 901 can reserve a storage area corresponding to the storage unit in the main storage device 902 or the auxiliary storage device 903 according to a program. The control unit can make the processor 901 perform processing of adding, updating and deleting data in the storage unit according to various programs.

The database refers to a relational database and is for associating and managing data aggregates referred to as tables or masters in a table form that is structurally defined by rows and columns. In the database, a table is referred to as a table or master, a column of a table is referred to as a column, and a row of a table is referred to as a record. In the relational database, a relationship between tables or masters is set, and the relationship may be referred to an association.

Typically, a column serving as a primary key for uniquely locating a record is set in each table or master. However, setting a column serving as a primary key is not essential. The control unit can make the processor 901 perform addition, deletion and update of record in a particular table or master stored in the storage unit.

The communication unit is implemented by the communication IF 991. The communication unit implements a function of communicating with another computer 90 via a network. The communication unit can receive information transmitted from another computer 90 and input the information to the control unit. The control unit can make the processor 901 perform information processing on the received information. The communication unit can also transmit information output from the control unit to the other computer 90.

### APPENDICES

The items described in the above embodiments will be listed as appendices below.

### Appendix 1

A program for storing call data concerning a call between a user and a customer in an external CRM system, in an information processing system that comprises a processor and a storage unit and provides a call service between the user and the customer, wherein the program makes the processor perform: a detection step (S602) of detecting a start of the call with the customer stored in the CRM system; and a linkage step (S603, S604, S607, S608, S609) of transmitting, to the CRM system, a request for storing call data concerning the call with the customer in association with the customer.

This allows the call data concerning the call with the customer to be stored in the CRM system 30 without complicated operations.

### Appendix 2

The program according to Appendix 1, wherein the detection step includes a step of the user originating a call to a telephone number of the customer stored in the CRM system or a step of the user receiving a call from the telephone number of the customer stored in the CRM system, and the start of the call with the customer being regarded as the detection of the start of the call with the customer.

This allows the call data concerning the call with the customer to be stored in the CRM system 30 without complicated operations.

### Appendix 3

The program according to Appendix 1 or 2, wherein the linkage step includes: a first linkage step (S603, S604) of transmitting, to the CRM system, a request for storing a first call data concerning the call with the customer in association with the customer when the start of the call between the user and the customer is detected in the detection step.

This allows the user to store the call data concerning the call with the customer in the CRM system 30 without waiting for the end of the call after the call is started.

### Appendix 4

The program according to any one of Appendices 1 to 3, wherein the linkage step includes: a second linkage step (S608) of transmitting, to the CRM system, a request for storing second call data concerning the call with the customer in association with the customer when an end of the call is detected.

This allows the user to store the call data concerning the call with the customer in the CRM system 30 after the end of the call.

### Appendix 5

A program for storing call data concerning a call between a user and a customer in an external CRM system, in an information processing system that comprises a processor and a storage unit and provides a call service between the user and the customer, wherein the program makes the processor perform: a detection step (S602) of detecting a start of the call with the customer stored in the CRM system; an obtaining step (S603) of obtaining any linkage mode of a first mode and a second mode as a linkage mode for the CRM system; a first linkage step (S603, S604) of transmitting, to the CRM system, a request for storing first call data concerning the call with the customer in association with the customer when the obtained linkage mode is the first mode, and refraining from transmitting the request for storing to the CRM system when the obtained linkage mode is the second mode when the start of the call between the user and the customer is detected in the detection step; and a second linkage step (S608) of transmitting, to the CRM system, a request for storing second call data concerning the call with the customer in association with the customer when the obtained linkage mode is the second mode when an end of the call is detected.

This allows the user to store the call data concerning the call with the customer in the CRM system 30 without complicated operations by selectively switching between the first mode in which the call data concerning the call with the customer is stored without waiting for the end of the call after the call with the customer is started and the second mode in which the call data concerning the call with the customer is stored after the end of the call with the customer.

### Appendix 6

The program according to Appendix 5, wherein the detection step includes a step of the user originating a call to a telephone number of the customer stored in the CRM system or a step of the user receiving a call from the telephone number of the customer stored in the CRM system, and the start of the call with the customer being regarded as the detection of the start of the call with the customer.

This allows the user to store the call data concerning the call with the customer in the CRM system 30 without complicated operations by selectively switching between the first mode in which the call data concerning the call with the customer is stored without waiting for the end of the call after the call with the customer is started and the second mode in which the call data concerning the call with the customer is stored after the end of the call with the customer.

### Appendix 7

The program according to Appendix 5 or 6, wherein the first call data includes data concerning the call that can be obtained after the call is started until the call is ended, and the second call data includes data concerning the call that can be obtained after the call is ended.

This allows the call data concerning the call with the customer to be stored in the CRM system 30 without complicated operations.

### Appendix 8

The program according to any one of Appendices 5 to 7, wherein the second linkage step includes a step (S607, S609) of additionally storing, in the CRM system, third call data concerning the call with the customer in association with the customer in such a manner that the first call data is not overwritten when the linkage mode is the first mode when the end of the call between the user and the customer is detected in the detection step.

This allows the call data to be stored in the CRM system 30 in such a manner that the data is not overwritten after the end of the call even in the first mode.

### Appendix 9

The program according to Appendix 8, wherein the third call data includes the data concerning the call that can be obtained after the call is ended from which data included in the first call data is omitted.

This allows the call data concerning the call with the customer to be stored in the CRM system 30 without complicated operations.

### Appendix 10

The program according to any one of Appendices 5 to 9, wherein the first call data includes call data identification information for identifying the call, information about the user and a date and time of start of the call, and the second call data includes the call data identification information for identifying the call, the information about the user, the date and time of start of the call, a date and time of end of the call, and audio recognition information concerning the call or summary information concerning the call.

This allows basic information, such as the date and time of start of a call, to be stored in the CRM system 30 without waiting for the end of the call in the first mode and allows detailed information concerning the call, such as the audio recognition information, the summary information or the URL for referring to the analysis data, to be stored in the CRM system 30 in the second mode.

### Appendix 11

The program according to Appendix 8 or 9, wherein the third call data includes at least a date and time of end of the call and audio recognition information concerning the call or summary information concerning the call.

This allows detailed information concerning the call with the customer, such as the audio recognition information, the summary information or the analysis data concerning the call, to be stored in the CRM system 30 in such a manner that the data already stored is not overwritten after the end of the call with the customer even in the first mode.

### Appendix 12

The program according to any one of Appendices 1 to 11, wherein the program makes the processor perform: a step of transmitting a request for displaying an analysis result concerning the call to the CRM system; a step of transmitting analysis data concerning the call to the CRM system in response to a request for the analysis data from the CRM system having received the request for displaying the analysis result; and a display step of displaying the analysis data visualized by the CRM system.

This allows the user to visually grasp the analysis data concerning the call while checking customer management information such as the customer information and the conversation history stored in the CRM system 30. The user can more quickly grasp the content of the call with the customer. If the user is a sales person, for example, the user can efficiently make reports on sales activities or the like.

### Appendix 13

The program according to Appendix 12, wherein the display step is a step of selectively displaying customer information stored in the CRM system or the analysis data visualized by the CRM system in one screen or displaying the customer information and the analysis data side by side in one screen.

This allows the user to visually grasp the analysis data concerning the call while checking customer management information such as the customer information and the conversation history stored in the CRM system 30. The user can quickly grasp the conversation history concerning the customer in more detail. If the user is a sales person, for example, the user can efficiently make reports on sales activities or the like.

### Appendix 14

An information processing system for storing call data concerning a call between a user and a customer in an external CRM system, the information processing system comprising a processor and a storage unit and providing a call service between the user and the customer, wherein the processor performs: a detection step (S602) of detecting a start of a call with the customer stored in the CRM system; and a linkage step (S603, S604, S607, S608, S609) of transmitting, to the CRM system, a request for storing call data concerning the call with the customer in association with the customer.

This allows the user to store the call data concerning the call with the customer in the CRM system 30 without complicated operations by selectively switching between the first mode in which the call data concerning the call with the customer is stored without waiting for the end of the call after the call with the customer is started and the second mode in which the call data concerning the call with the customer is stored after the end of the call with the customer.

### Appendix 15

In an information processing system that comprises a processor and a storage unit and provides a call service between a user and a customer, an information processing method for storing call data concerning a call between the user and the customer in an external CRM system, wherein the processor performs: a detection step (S602) of detecting a start of the call with the customer stored in the CRM system; and a linkage step (S603, S604, S607, S608, S609) of transmitting, to the CRM system, a request for storing call data concerning the call with the customer in association with the customer.

This allows the user to store the call data concerning the call with the customer in the CRM system 30 without complicated operations by selectively switching between the first mode in which the call data concerning the call with the customer is stored without waiting for the end of the call after the call with the customer is started and the second mode in which the call data concerning the call with the customer is stored after the end of the call with the customer.

### REFERENCE SIGNS LIST

1 information processing system
10 server
101 storage unit
103 control unit
20A, 20B, 20C user terminal
201 storage unit
204 control unit
30 CRM system
301 storage unit
304 control unit
50A, 50B, 50C customer terminal
501 storage unit
504 control unit

1. An information processing system for storing call data concerning a call between a user and a customer in an external CRM system, in an information processing system that comprises a processing circuitry and a storage and provides a call service between the user and the customer,
wherein the processing circuitry perform:
a detection step of detecting a start of the call with the customer stored in the CRM system; and
a linkage step of transmitting, to the CRM system, a request for storing call data concerning the call with the customer in association with the customer.

2. The information processing system according to claim 1, wherein the detection step includes a step of the user originating a call to a telephone number of the customer stored in the CRM system or a step of the user receiving a call from the telephone number of the customer stored in the CRM system, and the start of the call with the customer being regarded as the detection of the start of the call with the customer.

3. The information processing system according to claim 1, wherein the linkage step includes:
a first linkage step of transmitting, to the CRM system, a request for storing a first call data concerning the call with the customer in association with the customer when the start of the call between the user and the customer is detected in the detection step.

4. The information processing system according to claim 1, wherein the linkage step includes:
a second linkage step of transmitting, to the CRM system, a request for storing second call data concerning the call with the customer in association with the customer when an end of the call is detected.

5. A information processing system for storing call data concerning a call between a user and a customer in an external CRM system, in an information processing system that comprises a processing circuitry and a storage and provides a call service between the user and the customer,
wherein the processing circuitry perform:
a detection step of detecting a start of the call with the customer stored in the CRM system;
an obtaining step of obtaining any linkage mode of a first mode and a second mode as a linkage mode for the CRM system;
a first linkage step of transmitting, to the CRM system, a request for storing first call data concerning the call with the customer in association with the customer when the obtained linkage mode is the first mode, and
refraining from transmitting the request for storing to the CRM system when the obtained linkage mode is the second mode
when the start of the call between the user and the customer is detected in the detection step; and
a second linkage step of transmitting, to the CRM system, a request for storing second call data concerning the call with the customer in association with the customer when the obtained linkage mode is the second mode
when an end of the call is detected.

6. The information processing system according to claim 5, wherein the detection step includes a step of the user originating a call to a telephone number of the customer stored in the CRM system or a step of the user receiving a call from the telephone number of the customer stored in the CRM system, and the start of the call with the customer being regarded as the detection of the start of the call with the customer.

7. The information processing system according to claim 5, wherein the first call data includes data concerning the call that can be obtained after the call is started until the call is ended, and
the second call data includes data concerning the call that can be obtained after the call is ended.

8. The information processing system according to claim 5, wherein the second linkage step includes a step of additionally storing, in the CRM system, third call data concerning the call with the customer in association with the customer in such a manner that the first call data is not overwritten when the linkage mode is the first mode when the end of the call between the user and the customer is detected in the detection step.

9. The information processing system according to claim 8, wherein the third call data includes the data concerning the call that can be obtained after the call is ended from which data included in the first call data is omitted.

10. The information processing system according to claim 5, wherein the first call data includes call data identification information for identifying the call, information about the user and a date and time of start of the call, and
the second call data includes the call data identification information for identifying the call, the information about the user, the date and time of start of the call, a date and time of end of the call, and audio recognition information concerning the call or summary information concerning the call.

11. The information processing system according to claim 8, wherein the third call data includes at least a date and time of end of the call and audio recognition information concerning the call or summary information concerning the call.

12. The information processing system according to claim 1, wherein the processing circuitry perform:
a step of transmitting a request for displaying an analysis result concerning the call to the CRM system;
a step of transmitting analysis data concerning the call to the CRM system in response to a request for the analysis data from the CRM system having received the request for displaying the analysis result; and
a display step of displaying the analysis data visualized by the CRM system.

13. The information processing system according to claim 12, wherein the display step is a step of selectively displaying customer information stored in the CRM system or the analysis data visualized by the CRM system in one screen or displaying the customer information and the analysis data side by side in one screen.

14. In an information processing system that comprises a processing circuitry and a storage and provides a call service between a user and a customer, an information processing method for storing call data concerning a call between the user and the customer in an external CRM system,
wherein the processing circuitry performs:
a detection step of detecting a start of the call with the customer stored in the CRM system; and
a linkage step of transmitting, to the CRM system, a request for storing call data concerning the call with the customer in association with the customer.
